(19) United States
(12) Patent Application Publication
(10) Pub. No.: US 2023/0289776 A1
(43) Pub. Date: Sep. 14, 2023

(54) SYSTEMS AND METHODS OF PERSONALIZING SERVICES ASSOCIATED WITH RESTAURANTS FOR PROVIDING A MARKETPLACE FOR FACILITATING TRANSACTIONS

(71) Applicant: Balaji Kannaiyan, Cary, NC (US)

(72) Inventor: Balaji Kannaiyan, Cary, NC (US)

(73) Assignee: RMINT Inc, Cary, NC (US)

(21) Appl. No.: 18/116,881

(22) Filed: Mar. 3, 2023

Related U.S. Application Data
(60) Provisional application No. 63/317,664, filed on Mar. 8, 2022.

(51) Int. Cl. G06Q 20/36; G06Q 20/38; G06Q 20/40

(52) U.S. Cl. CPC G06Q 20/363; G06Q 20/389; G06Q 20/401

(57) ABSTRACT

The present disclosure provides a method of personalizing services associated with restaurants for providing a marketplace for facilitating transactions. Furthermore, the method may include analyzing, using a processing device, the one or more user data using one or more machine learning models. Moreover, the method may include generating, using the processing device, a menu of one or more restaurants for one or more customers based on the determining of the one or more recipes. Further, the menu may be comprised of one or more foods created using the one or more recipes. Accordingly, the method may include transmitting, using the communication device, the menu to one or more restaurant devices associated with the one or more restaurants.

### CROSS-REFERENCE TO RELATED APPLICATION

This application claims the benefit of U.S. Provisional Patent Application No. 63/317,664, titled “SYSTEM AND METHOD FOR SECURE RECIPE MARKETPLACE AND TRANSACTIONS”, filed 8 Mar. 2022, which is incorporated by reference herein in its entirety.

### FIELD OF DISCLOSURE

Generally, the present disclosure relates to the field of data processing. More specifically, the present disclosure relates to systems and methods of personalizing services associated with restaurants for providing a marketplace for facilitating transactions.

### BACKGROUND

The field of data processing is technologically important to several industries, business organizations, and/or individuals.

Recipes are notoriously difficult to protect. Generally, lists of ingredients are not protectable, and the instructions accompanying a recipe are only “functional directions” and are not protected under copyright law. On the other hand, developing new recipes is time-consuming and can be costly, due to the need to purchase ingredients to test new recipes under development.

Therefore, there is a need for improved methods, systems, apparatuses, and devices for facilitating personalizing services associated with restaurants for providing a marketplace for facilitating transactions that may overcome one or more of the above-mentioned problems and/or limitations.

### SUMMARY OF DISCLOSURE

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

The present disclosure provides a method of personalizing services associated with restaurants for providing a marketplace for facilitating transactions. Also, the method may include receiving, using a communication device, one or more user data associated with one or more users from one or more devices. Accordingly, the one or more users include one or more customers of one or more restaurants. Further, the method may include analyzing, using a processing device, the one or more user data using one or more machine learning models. Additionally, the method may include determining, using the processing device, one or more preferences of the one or more customers based on the analyzing. Also, the method may include determining, using the processing device, one or more recipes preferred by the one or more customers based on the determining of the one or more preferences. Further, the method may include generating, using the processing device, a menu of the one or more restaurants for the one or more customers based on the determining of the one or more recipes. Accordingly, the menu may be comprised of one or more foods created using the one or more recipes. Additionally, the method may include transmitting, using the communication device, the menu to one or more restaurant devices associated with the one or more restaurants. Also, the method may include storing, using a storage device, the one or more preferences of the one or more users for the one or more recipes in a distributed ledger.

The present disclosure provides a system for personalizing services associated with restaurants for providing a marketplace for facilitating transactions. Additionally, the system may include a communication device configured for receiving one or more user data associated with one or more users from one or more devices. Further, the one or more users include one or more customers of one or more restaurants. Further, the communication device may be configured for transmitting a menu to one or more restaurant devices associated with the one or more restaurants. Furthermore, the system may include a processing device communicatively coupled with the communication device. Moreover, the processing device may be configured for analyzing the one or more user data using one or more machine learning models. Accordingly, the processing device may be configured for determining one or more preferences of the one or more customers based on the analyzing. Furthermore, the processing device may be configured for determining one or more recipes preferred by the one or more customers based on the determining of the one or more preferences. Moreover, the processing device may be configured for generating the menu of the one or more restaurants for the one or more customers based on the determining of the one or more recipes. Further, the menu may be comprised of one or more foods created using the one or more recipes. Accordingly, the system may include a storage device communicatively coupled with the processing device. Further, the storage device may be configured for storing the one or more preferences of the one or more users for the one or more recipes in a distributed ledger.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTIONS OF DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is an illustration of an online platform 100 consistent with various embodiments of the present disclosure.

FIG. 2 is a block diagram of a computing device 200 for implementing the methods disclosed herein, in accordance with some embodiments.

FIG. 3A illustrates a flowchart of a method 300 of personalizing services associated with restaurants for providing a marketplace for facilitating transactions, in accordance with some embodiments.

FIG. 3B illustrates a continuation of the flowchart of the method 300 of personalizing services associated with restaurants for providing a marketplace for facilitating transactions, in accordance with some embodiments.

FIG. 4 illustrates a flowchart of a method 400 of personalizing services associated with restaurants for providing a marketplace for facilitating transactions, in accordance with some embodiments.

FIG. 5 illustrates a flowchart of a method 500 of personalizing services associated with restaurants for providing a marketplace for facilitating transactions, in accordance with some embodiments.

FIG. 6 illustrates a flowchart of a method 600 of personalizing services associated with restaurants for providing a marketplace for facilitating transactions, in accordance with some embodiments.

FIG. 7 illustrates a flowchart of a method 700 of personalizing services associated with restaurants for providing a marketplace for facilitating transactions, in accordance with some embodiments.

FIG. 8 illustrates a flowchart of a method 800 of personalizing services associated with restaurants for providing a marketplace for facilitating transactions, in accordance with some embodiments.

FIG. 9 illustrates a flowchart of a method 900 of personalizing services associated with restaurants for providing a marketplace for facilitating transactions, in accordance with some embodiments.

FIG. 10 illustrates a flowchart of a method 1000 of personalizing services associated with restaurants for providing a marketplace for facilitating transactions, in accordance with some embodiments.

FIG. 11 illustrates a block diagram of a system 1100 of personalizing services associated with restaurants for providing a marketplace for facilitating transactions, in accordance with some embodiments.

FIG. 12 illustrates a block diagram of the system 1100 of personalizing services associated with restaurants for providing a marketplace for facilitating transactions, in accordance with some embodiments.

FIG. 13A shows a system 1300 for facilitating recording recipes on a blockchain and selling the recipes through a marketplace, in accordance with some embodiments.

FIG. 13B is a flowchart of a method (process) 1350 for facilitating recording recipes on a blockchain and selling them through a marketplace, in accordance with some embodiments.

FIG. 14 is a flow diagram of a method 1400 for a recipe transaction, in accordance with some embodiments.

FIG. 15 is a flow diagram of a method 1500 for integrating recipe transactions with social media and the metaverse, in accordance with some embodiments.

FIG. 16A is a flow diagram of a method (process) 1600 for demand prediction and sales flow, in accordance with some embodiments.

FIG. 16B is a flow diagram of a method (process) 1650 for moderating bidding, clearing, distribution, and metadata information for facilitating the demand prediction and the sales flow, in accordance with some embodiments.

FIG. 17 is a block diagram of a blockchain-enabled system 1700 for recipe transactions, in accordance with some embodiments.

FIG. 18 is a block diagram of a system 1800 for creating a private market for cooking recipes on a blockchain, in accordance with some embodiments.

FIG. 19 is a block diagram of a system 1900 for integrating an online marketplace and offline restaurants, in accordance with some embodiments.

FIG. 20 is a block diagram of a system 2000 for organizing marketplace participants and networks associated with the marketplace participants, in accordance with some embodiments.

FIG. 21 is a block diagram of a system 2100 for moderating trades of recipe crypto assets, in accordance with some embodiments.

FIG. 22 is a flow diagram of a method 2200 for creating a new private market and a marketplace for cooking recipes on a blockchain, in accordance with some embodiments. FIG. 23 is a flow diagram of a method 2300 for creating a new crypto private market, in accordance with some embodiments.

FIG. 24 is a flow diagram of a method 2400 to create a new NFT marketplace from the newly created crypto private market, in accordance with some embodiments.

FIG. 25 is a flow diagram of a method 2500 for creating a co-pilot to run distributed restaurant, in accordance with some embodiments.

FIG. 26 is a flow diagram of a method 2600 for tokenizing content, recipes, and menus, in accordance with some embodiments.

FIG. 27 is a flow diagram of a method 2700 to tokenize physical restaurants in accordance with some embodiments.

FIG. 28 is a flow diagram of a method 2800 to tokenize the discovery of new services and new kinds of restaurants and meal delivery services, in accordance with some embodiments.

FIG. 29 is a flow diagram of a method 2900 to discover personalized content for the audience, in accordance with some embodiments.

FIG. 30 is a flow diagram of a method 3000 to discover operational intelligence for distributed meal service comprising restaurants, in accordance with some embodiments.

FIG. 31 is a flow chart of a method 3100 to create a co-pilot for distributed restaurants and connects it to the customers based on the discovery services from the marketplace, in accordance with some embodiments.

### DETAILED DESCRIPTION OF DISCLOSURE

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim limitation found herein and/or issuing here from that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the claims found herein and/or issuing here from. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of the disclosed use cases, embodiments of the present disclosure are not limited to use only in this context.

In general, the method disclosed herein may be performed by one or more computing devices (also referred to as devices). For example, in some embodiments, the method may be performed by a server computer in communication with one or more client devices (also referred to as devices) over a communication network such as, for example, the Internet. In some other embodiments, the method may be performed by one or more of at least one server computer, at least one client device, at least one network device, at least one sensor and at least one actuator. Examples of the one or more client devices and/or the server computer may include, a desktop computer, a laptop computer, a tablet computer, a personal digital assistant, a portable electronic device, a wearable computer, a smart phone, an Internet of Things (IoT) device, a smart electrical appliance, a video game console, a rack server, a super-computer, a mainframe computer, mini-computer, micro-computer, a storage server, an application server (e.g. a mail server, a web server, a real-time communication server, an FTP server, a virtual server, a proxy server, a DNS server etc.), a quantum computer, and so on. Further, one or more client devices and/or the server computer may be configured for executing a software application such as, for example, but not limited to, an operating system (e.g. Windows, Mac OS, Unix, Linux, Android, etc.) in order to provide a user interface (e.g. GUI, touch-screen based interface, voice based interface, gesture based interface etc.) for use by the one or more users and/or a network interface for communicating with other devices over a communication network. Accordingly, the server computer may include a processing device configured for performing data processing tasks such as, for example, but not limited to, analyzing, identifying, determining, generating, transforming, calculating, computing, compressing, decompressing, encrypting, decrypting, scrambling, splitting, merging, interpolating, extrapolating, redacting, anonymizing, encoding and decoding. Further, the server computer may include a communication device configured for communicating with one or more external devices. The one or more external devices may include, for example, but are not limited to, a client device, a third party database, public database, a private database and so on. Further, the communication device may be configured for communicating with the one or more external devices over one or more communication channels. Further, the one or more communication channels may include a wireless communication channel and/or a wired communication channel. Accordingly, the communication device may be configured for performing one or more of transmitting and receiving of information in electronic form. Further, the server computer may include a storage device configured for performing data storage and/or data retrieval operations. In general, the storage device may be configured for providing reliable storage of digital information. Accordingly, in some embodiments, the storage device may be based on technologies such as, but not limited to, data compression, data backup, data redundancy, deduplication, error correction, data finger-printing, role based access control, and so on.

Further, one or more steps of the method disclosed herein may be initiated, maintained, controlled and/or terminated based on a control input received from one or more devices operated by one or more users such as, for example, but not limited to, an end user, an admin, a service provider, a service consumer, an agent, a broker and a representative thereof. Further, the user as defined herein may refer to a human, an animal or an artificially intelligent being in any state of existence, unless stated otherwise, elsewhere in the present disclosure. Further, in some embodiments, the one or more users may be required to successfully perform authentication in order for the control input to be effective. In general, a user of the one or more users may perform authentication based on the possession of a secret human readable secret data (e.g. username, password, passphrase, PIN, secret question, secret answer etc.) and/or possession of a machine readable secret data (e.g. encryption key, decryption key, bar codes, etc.) and/or possession of one or more embodied characteristics unique to the user (e.g. biometric variables such as, but not limited to, fingerprint, palm-print, voice characteristics, behavioral characteristics, facial features, iris pattern, heart rate variability, evoked potentials, brain waves, and so on) and/or possession of a unique device (e.g. a device with a unique physical and/or chemical and/or biological characteristic, a hardware device with a unique serial number, a network device with a unique IP/MAC address, a telephone with a unique phone number, a smartcard with an authentication token stored thereupon, etc.). Accordingly, the one or more steps of the method may include communicating (e.g. transmitting and/or receiving) with one or more sensor devices and/or one or more actuators in order to perform authentication. For example, the one or more steps may include receiving, using the communication device, the secret human-readable data from an input device such as, for example, a keyboard, a keypad, a touch-screen, a microphone, a camera and so on. Likewise, the one or more steps may include receiving, using the communication device, the one or more embodied characteristics from one or more biometric sensors.

Further, one or more steps of the method may be automatically initiated, maintained and/or terminated based on one or more predefined conditions. In an instance, the one or more predefined conditions may be based on one or more contextual variables. In general, the one or more contextual variables may represent a condition relevant to the performance of the one or more steps of the method. The one or more contextual variables may include, for example, but are not limited to, location, time, identity of a user associated with a device (e.g. the server computer, a client device etc.) corresponding to the performance of the one or more steps, environmental variables (e.g. temperature, humidity, pressure, wind speed, lighting, sound, etc.) associated with a device corresponding to the performance of the one or more steps, physical state and/or physiological state and/or psychological state of the user, physical state (e.g. motion, direction of motion, orientation, speed, velocity, acceleration, trajectory, etc.) of the device corresponding to the performance of the one or more steps and/or semantic content of data associated with the one or more users. Accordingly, the one or more steps may include communicating with one or more sensors and/or one or more actuators associated with the one or more contextual variables. For example, the one or more sensors may include, but are not limited to, a timing device (e.g. a real-time clock), a location sensor (e.g. a GPS receiver, a GLONASS receiver, an indoor location sensor etc.), a biometric sensor (e.g. a fingerprint sensor), an environmental variable sensor (e.g. temperature sensor, humidity sensor, pressure sensor, etc.) and a device state sensor (e.g. a power sensor, a voltage/current sensor, a switch-state sensor, a usage sensor, etc. associated with the device corresponding to performance of the or more steps).

Further, the one or more steps of the method may be performed one or more number of times. Additionally, the one or more steps may be performed in any order other than as exemplarily disclosed herein, unless explicitly stated otherwise, elsewhere in the present disclosure. Further, two or more steps of the one or more steps may, in some embodiments, be simultaneously performed, at least in part. Further, in some embodiments, there may be one or more time gaps between performance of any two steps of the one or more steps.

Further, in some embodiments, the one or more predefined conditions may be specified by the one or more users. Accordingly, the one or more steps may include receiving, using the communication device, the one or more predefined conditions from one or more and devices operated by the one or more users. Further, the one or more predefined conditions may be stored in the storage device. Alternatively, and/or additionally, in some embodiments, the one or more predefined conditions may be automatically determined, using the processing device, based on historical data corresponding to performance of the one or more steps. For example, the historical data may be collected, using the storage device, from a plurality of instances of performance of the method. Such historical data may include performance actions (e.g. initiating, maintaining, interrupting, terminating, etc.) of the one or more steps and/or the one or more contextual variables associated therewith. Further, machine learning may be performed on the historical data in order to determine the one or more predefined conditions. For instance, machine learning on the historical data may determine a correlation between one or more contextual variables and performance of the one or more steps of the method. Accordingly, the one or more predefined conditions may be generated, using the processing device, based on the correlation.

Further, one or more steps of the method may be performed at one or more spatial locations. For instance, the method may be performed by a plurality of devices interconnected through a communication network. Accordingly, in an example, one or more steps of the method may be performed by a server computer. Similarly, one or more steps of the method may be performed by a client computer. Likewise, one or more steps of the method may be performed by an intermediate entity such as, for example, a proxy server. For instance, one or more steps of the method may be performed in a distributed fashion across the plurality of devices in order to meet one or more objectives. For example, one objective may be to provide load balancing between two or more devices. Another objective may be to restrict a location of one or more of an input data, an output data and any intermediate data therebetween corresponding to one or more steps of the method. For example, in a client-server environment, sensitive data corresponding to a user may not be allowed to be transmitted to the server computer. Accordingly, one or more steps of the method operating on the sensitive data and/or a derivative thereof may be performed at the client device.

Overview:

The present disclosure describes systems and methods of personalizing services associated with restaurants for providing a marketplace for facilitating transactions. Further, the disclosed system may be configured for providing a secure recipe marketplace and transactions. Further, the disclosed system may be configured for providing the marketplace that is secured through blockchain. Each recipe may be preferably recorded as an NFT (non-fungible token) on a blockchain. The system creates a private market for cooking recipes as mediated transparently through the blockchain. To support such a marketplace, preferably purchases and/or rentals are mediated through an online marketplace for cooking and delivering niche recipes. This embodiment of the disclosed system preferably features the integration of the online blockchain-based marketplace with offline restaurants, through the execution of smart contracts.

Optionally and preferably, the disclosed system features a discovery component that matches chefs and recipe creators with consumers of such recipes, more preferably based on their multitude of preferences in this unique marketplace. To encourage the creation of recipes of a popular type, in at least some embodiments, the system preferably moderates the bidding, clearing, distribution, and metadata reveal of smart contracts.

In some embodiments, cookbook authors, recipe creators, and chefs may be able to convert at least the recipes, and optionally also associated text, videos, and secrets to an asset on a smart contract, such as an NFT for example. Such an asset enables the creators to sell, buy, lease, and otherwise provide their recipes directly to the intended consumer without a middleman. This process helps them to earn their income directly from the end customers. Further, a smart contract platform for the system as described herein builds a layer of trust between creator and consumer, thus creating a private market for cooking recipes.

By building a private marketplace for trading cooking recipes and cooking recipes with secrets, ownership of recipes on the internet is more easily established. Furthermore, the system supports recipe creators to also trade the associated secrets that pertain to that recipe. This builds a layer of trust between creators and consumers of the marketplace, as well as enables secrets to be traded.

In some embodiments, niche recipe creators are able to lease and/or sell recipes to restaurants. Further, consumers preferably may also have the option to choose the recipes the consumers like and to order food based on these recipes, for example through the discovery of new restaurants, caterers, and/or other prepared meal providers. Further, the disclosed system may be configured for allows restaurants to access private marketplaces and audiences in the marketplace, thereby integrating restaurants and the marketplace, while avoiding menu congestion with less popular recipes. Further, the disclosed system moves point-of-sale to the online marketplace. This integration allows marketplace demand and supply signals to be provided to offline restaurants and vice versa. For example, a restaurant may indicate to the marketplace that a particular type of recipe is more popular, and hence may stimulate the creation of more recipes of that type.

With the ownership of the asset established, it is possible to trade or lease the recipes. The disclosed system creates a unique marketplace for niche recipes. The unique online marketplace may be integrated with offline restaurants, to build a unique way to deliver recipes and menus that the audience chooses. Further, smart contracts are preferably used to integrate online marketplace with offline restaurants.

In some embodiments, the system supports the design of new NFT-based restaurants for niche recipes eliminating the need for “menu congestion”. For example, the disclosed system may allow celebrity or otherwise popular chefs to support distributed or franchised restaurants that are operated without their physical presence. For example, these restaurants may be new NFT-based restaurants that run their operations on the blockchain. Furthermore, such NFTs may be used as incentive mechanisms to build a new class of restaurants called “Smart Social Restaurants”.

In some embodiments, the recipe creators may be matched with audiences based on a multitude of preferences through a discovery and matching system as described in greater detail below. The discovery and matching system preferably also supports predicting the audience for each kind of recipe. Further, the disclosed system may preferably encode various signals from private markets and marketplaces to build models that can match creators to audiences and audiences to creators. The system preferably also supports personalizing recipes and creators based on audience preference.

Such a matching system preferably supports matching the audience (consumers) with the recipe creators based on a multitude of preferences. This matching process brings the audience and creators directly in touch with one another to transact business, and preferably also enables multidimensional personalization.

In some embodiments, the system preferably enables cooking recipes to become first-class assets that can be traded. This trade-ability increases the liquidity of assets and may help the creator to own the transactions. Furthermore, the increased trade-ability and liquidity may help to build a thick marketplace for niche recipes. Further, the marketplace may support new and different marketplace transactions and also validates marketplace transactions.

Furthermore, the disclosed system enables the creators to own the entire transaction and to mediate their audience. Further, this market mechanism converts cooking recipes to first-class crypto assets, thus creating value for the creators. The marketplace platform also preferably predicts the demand for various recipes depending on a multitude of factors. The marketplace platform preferably also ranks these recipes on various marketplace metrics, thereby increasing the pace of liquidity for various recipes.

Further, a blockchain is a distributed database that maintains a list of data records, the security of which is enhanced by the distributed nature of the blockchain. Further, the blockchain typically includes several nodes, which may be one or more systems, machines, computers, databases, data stores, or the like operably connected with one another. In some cases, each of the nodes or multiple nodes is maintained by different entities. Further, the blockchain typically works without a central repository or single administrator. One well-known application of a blockchain is the public ledger of transactions for cryptocurrencies such as those used in bitcoin. The recorded data records on the blockchain are enforced cryptographically and stored on the nodes of the blockchain. A blockchain provides numerous advantages over traditional databases. A large number of nodes of a blockchain may reach a consensus regarding the validity of a transaction contained on the transaction ledger. Similarly, when multiple versions of a document or transaction exist on the ledger, multiple nodes can converge on the most up-to-date version of the transaction. For example, in the case of a virtual currency transaction, any node within the blockchain that creates a transaction can determine within a level of certainty whether the transaction can take place and become final by confirming that no conflicting transactions (i.e., the same currency unit has not already been spent) confirmed by the blockchain elsewhere. The blockchain typically has two primary types of records. The first type is the transaction type, which consists of the actual data stored in the blockchain. The second type is the block type, which are records that confirm when and in what sequence certain transactions became recorded as part of the blockchain. Transactions are created by participants using the blockchain in its normal course of business, for example, when someone sends cryptocurrency to another person), and blocks are created by users known as “miners” who use specialized software/equipment to create blocks. Users of the blockchain create transactions that are passed around to various nodes of the blockchain. A “valid” transaction is one that can be validated based on a set of rules that are defined by the particular system implementing the blockchain.

In some blockchain systems, miners are incentivized to create blocks by a rewards structure that offers a pre-defined per-block reward and/or fees offered within the transactions validated themselves. Thus, when a miner successfully validates a transaction on the blockchain, the miner may receive rewards and/or fees as an incentive to continue creating new blocks.

Preferably, the blockchain(s) that is/are implemented are capable of running code, to facilitate the use of smart contracts. Smart contracts are computer processes that facilitate, verify

and/or enforce negotiation and/or performance of a contract between parties. One fundamental purpose of smart contracts is to integrate the practice of contract law and related business practices with electronic commerce protocols between people on the Internet. Smart contracts may leverage a user interface that provides one or more parties or administrators access, that may be restricted at varying levels for different people, to the terms and logic of the contract. Further, the smart contracts typically include logic that emulates contractual clauses that are partially or fully self-executing and/or self-enforcing. Examples of smart contracts are digital rights management (DRM) used for protecting copyrighted works, financial cryptography schemes for financial contracts, admission control schemes, token bucket algorithms, other quality of service mechanisms for assistance in facilitating network service level agreements, person-to-person network mechanisms for ensuring fair contributions of users, and others. Further, the smart contracts may also be described as pre-written logic (computer code), stored and replicated on a distributed storage platform (e.g. a blockchain), executed/run by a network of computers (which may be the same ones running the blockchain), which can result in ledger updates (cryptocurrency payments, etc.). Further, an infrastructure associated with the smart contract may be implemented by replicated asset registries and contract execution using cryptographic hash chains and Byzantine fault-tolerant replication. For example, each node in a peer-to-peer network or blockchain-distributed network may act as a title registry and escrow, thereby executing changes of ownership and implementing sets of predetermined rules that govern transactions on the network. Each node may also check the work of other nodes and in some cases, as noted above, function as a miners or validator.

Not all blockchains can execute all types of smart contracts. For example, Bitcoin cannot currently execute smart contracts. Sidechains, i.e. blockchains connected to Bitcoin's main blockchain could enable smart contract functionality: by having different blockchains running in parallel to Bitcoin, with an ability to jump value between Bitcoin's main chain and the side chains, side chains could be used to execute logic. Smart contracts that are supported by sidechains may be contemplated as being included within the blockchain-enabled smart contracts that are described below.

For all of these examples, security for the blockchain may optionally and preferably be provided through cryptography, such as public/private key, hash function, or digital signature, as is known in the art.

As described herein, the term “token” may also include tokens, coins, or NFTs (non-fungible tokens), or any digital asset for which at least title, and preferably provenance and chain of title, may be written to a blockchain.

In accordance with some embodiments, the disclosed system may create a private market and marketplace for cooking recipes on the blockchain, a new possibility is created for distributing, owning, sharing, and experiencing digital content in a personalized way and experiencing and consuming it offline as well. Further, the disclosed system redefines online and offline experiences for every stakeholder in the ecosystem. Further, the disclosed system may provide a new private market to tokenize various offline assets comprising of recipes, videos, blogs, technical know-how, cookbooks, menus, physical restaurants in a location, virtual restaurants in the metaverse, and online digital restaurants and convert them into crypto assets. Further, the disclosed system may provide a new marketplace to transact crypto assets that enhance the revenue potential of every stakeholder and improves customer satisfaction of customers. Personalization offers the ability to create a unique experience for the customer and a set of customers. Further, the disclosed system may be associated with a new co-pilot engine that manages the personalization of content to customers and the personalization of content to restaurants through recipes and menus is a new horizon in meal delivery services. Further, a new kind of distributed restaurant is possible because of all these technological breakthroughs to create new kinds of restaurants comprising NFT-enabled restaurants, AI-enabled restaurants, and AI-enabled and NFT-enabled meal delivery services, smart social restaurants using the disclosed system.

Further, the disclosed system may be configured for creating a new crypto asset class on the private market that gives an opportunity to create a new marketplace to trade crypto assets and personalize the distribution, own, share, and experience the online and offline behavior in a new way that was never done before. The discovery services of the private market and marketplace may create a new co-pilot that embodies the operational intelligence of all stakeholders. The operational intelligence of the co-pilot may create a new category of distributed restaurants that are NFT-enabled, AI-enabled, smart social restaurants. This is the new horizon to experience the magic of all these technologies working seamlessly to create and run an autonomous organization without human intervention.

Further, in some embodiments, the disclosed system may be configured for the creation of new private markets for cooking recipes and restaurants on the blockchain. The private market may allow the creation of a new marketplace where chefs, recipe creators, cookbook authors, influencers, restaurants, and meal delivery service providers can trade their services without a middleman. Further, the chefs, the recipe creators, the cookbook authors, the influencers, the restaurants, and the meal delivery service providers may include users. The private market may create a new market mechanism to make this asset (NFTs) and service transaction possible. As a consequence of the private market, the present disclosure describes a new marketplace where the assets and services are transacted thru various smart contracts. As a consequence of the new transaction mechanism, this invention claims that a new category of distributed and autonomous restaurants and delivery services is created that is NFT-enabled and AI-enabled distributed smart social restaurants.

Further, in some embodiments, the disclosed system may be configured for providing a secure recipe marketplace and transactions that are secured through blockchain. Each recipe is preferably recorded as an NFT (non-fungible token) on a blockchain. The system may create a private market for cooking recipes as mediated transparently through the blockchain. To support such a marketplace, preferably purchases and/or rentals are mediated through an online marketplace for cooking and delivering niche recipes. Further, the disclosed system may be configured for integration of the online blockchain-based marketplace with offline restaurants, through the execution of smart contracts.

Further, the disclosed system may be configured to create a private market for cooking recipes on the blockchain. Further, the disclosed system may convert the private market into a unique online marketplace for cooking and delivering niche recipes. By integrating online marketplace with offline restaurants with smart contracts. Further, the disclosed system may create Further, the disclosed system may match recipe creators with consumers based on their multitude of preferences in this unique marketplace. Further, the disclosed system may moderate the bidding, clearing, distribution, and metadata reveal of smart contracts. Further, the disclosed system may be configured for creating a private network on blockchain. Further, the disclosed system may receive input from user devices and wallets. Further, the disclosed system may receive recipes (videos, text, secrets, etc.) from user devices. Further, the disclosed system may be associated with a software platform. Further, the software platform may include a user interface to upload recipe content. Further, the user triggers the creation of a smart contract on RMINT (disclosed system) from the user device that contains their wallet address. Further, RMINT, an exemplary embodiment of the disclosed system herein, may process all the inputs and stores them in its own unique data model associated with this wallet. Further, RMINT may push the creator's recipe as a smart contract on the blockchain by encrypting all the secrets. All the creators' rules are encoded in the smart contracts. Further, creators may create fungible (ERC20) and non-fungible tokens (ERC721) and set various restrictions on this creation. Further, a new smart contract may be made available on the RMINT's marketplace and Metaverse. Further, the disclosed system may convert cooking recipes into first-class crypto assets and validates assets in a unique way to improve the liquidity of assets.

Further, the disclosed system may receive input using the smart contract of the recipe creator on blockchain and metadata of the recipes stored in the RMINT's database. Further, the smart contract flows through the marketplace networks to identify the right audience for the smart contract. Further, an online marketplace is integrated with offline restaurants and offline delivery restaurants through smart contracts. Further, the recipe marketplace, restaurant, and smart contracts may deliver many new capabilities to both customers and restaurants. All these capabilities are encoded thru smart contracts. Visibility of the entire transaction is tracked and controlled on the RMINTs platform from first-party wallet address to a second-party wallet address. Further, the disclosed system may move point-of-sale from offline to the online marketplace. This disclosed system moves demand generation to the online marketplace. This disclosed system moves payments and contract settlements to an online marketplace.

Further, in some embodiments, a process flow of marketplace networks with recipe creators and consumers based on their multitude of preferences is disclosed. Further, the disclosed system may receive input such as smart contracts, recipe metadata, and community users data. Further, RMINT—Discovery Engine builds the collaboration data with many dimensions and predicts the audience for the smart contract by connecting consumers with recipe creators. Further, RMINT may include building learning models for user preferences, location, and their community and associates with creators. Further, the process may include RMINT ranking the recipes for given user preferences and storing them in the data model. Further, the disclosed system structures a discovery mechanism for the marketplace. This discovery mechanism enables the hand-shake to happen between multiple parties involved in the market. Examples—Chefs, recipe creators, cookbook authors, consumers, and offline restaurants.

In further embodiments, a process flow for the moderation of bidding, clearing, distribution, and metadata reveal is disclosed. Further, the process may include input such as creator's smart contracts, recipe metadata, and community data (all are stored in the RMINTs database). Further, RMINT identifies the audience for the smart contract. Further, RMINT allows fungible (ERC20) and non-fungible (ERC721) tokens to trade on the marketplace. Further, RMINT controls the clearing and distribution of fungible and non-fungible tokens. Further, visibility of the entire transaction is tracked and controlled on the RMINTs platform from first-party wallet address to second-party wallets address. Further, based on the end-users action (buy/sell/lease), ownership transfers happen on the RMINT's databases and are also executed on the blockchain. Further, the RMINT NFT marketplace integrates on-chain (on-blockchain) activities (including Metaverse) with off-chain (not-on-blockchain) activities to render this marketplace moderation. Further, the disclosed system structures the distribution and visibility of marketplace design. The disclosed system integrates on-chain and off-chain activities. This invention creates a new delivery mechanism for recipe assets.

Further, cookbook authors, recipe creators, and chefs may convert the recipes into text, videos, and secrets on the smart contract that helps them to sell, buy, lease, and their recipes directly to the intended consumer without a middleman. This helps to earn their income directly from the end customers. RMINT builds a layer_of trust between creator and consumer thus creating a private market for cooking recipes. Further, the disclosed system may establish a layer of trust between creators and consumers. Niche recipe creators may lease/sell/buy recipes and lease them to restaurants. Consumers may have the option to choose the recipes they like to order the food based on it. This allows restaurants to access private marketplaces and audiences in the marketplace—(Integrates Marketplace+Restaurants—Unique Mode—Avoiding Menu congestion). The disclosed system moves point-of-sale to the online marketplace, and this integration allows marketplace demand and supply signals to be carried to off-line restaurants and vice versa. Further, recipe creators may be matched with audiences based on a multitude of preferences. Reliable system for predicting the audience for each kind of recipe. RMINT platform encodes various signals from private markets and marketplaces to build models that may match creators to audiences and audiences to creators. Further, the disclosed system may be a reliable system for personalizing recipes and creators based on audience preference. Further, cooking recipes become first-class assets that may be traded. This increases the liquidity of assets. This helps the creator to own the transactions. This builds a thick marketplace for niche recipes. This builds a new structure for the private markets and validates marketplace transactions. Further, the disclosed system may own the entire transaction to the creators and mediate their audience.

Further, the disclosed system may build a private marketplace for trading cooking recipes and cooking recipes with secrets. Further, the disclosed system may establish ownership of recipes on the internet and allows trading of the secrets that pertain to that recipe. This builds a layer of trust between creators and consumers of the marketplace. The disclosed system allows trading secrets. With the ownership of the asset established, it is possible to trade or lease the recipes. This creates a unique marketplace for niche recipes. The unique online marketplace may be integrated with offline restaurants building a unique way to deliver recipes and menus that the audience chooses. Further, the smart contracts may be used to integrate online marketplace with offline restaurants. Further, the disclosed system allows the designing of new NFT-based restaurants for niche recipes eliminating the need for “menu congestion”. The disclosed system allows celebrity chefs to run distributed or franchised restaurants to run without their presence. This reliably establishes celebrity chefs' reputations without their presence. Further, the disclosed system allows new NFT-based restaurants that will run their operations on the blockchain. NFTs are incentive mechanisms to build a new class of restaurants called “Smart Social Restaurants”. Further, to match the audience (consumers) with the recipe creators based on the multitude of preferences. Thus enabling trading that was not possible by any other means before. This brings the audience and creators directly in touch with one another to transact business. This enables multidimensional personalization.

Further, the disclosed system may be configured to convert the cooking recipes to first-class crypto assets. Thus creating value for the creators. RMINT may predict the demand for various recipes depending on a multitude of factors. RMINT will rank these recipes on various marketplace metrics. This may increase the pace of liquidity for various recipes. Further, a market mechanism is designed to make creators and consumers owners of the marketplace. Further, the system may provide a private marketplace structure on blockchain for cooking recipes. Further, the disclosed system may use unique data and data models to organize and scale distributed restaurants. Further, the disclosed system may provide a unique discovery engine to match recipe creators with the audience (Algorithms+Model). Further, the disclosed system may be based on the unique data model and data structures to convert the cooking recipes into first-class crypto assets with secrets. Further, the disclosed system may have a unique mechanism design to distribute the niche, in-demand cooking recipes with various market signals encoded in them.

Further, the present disclosure describes systems and methods for generating NFT tokens of content. Further, the disclosed system provides a platform (online platform) for users. Further, the user may upload one or more contents associated with recipes, restaurants, etc on the platform. Further, the platform analyzes the one or more contents and generates one or more NFT tokens for the one or more contents. Further, the one or more NFT tokens may include the one or more contents.

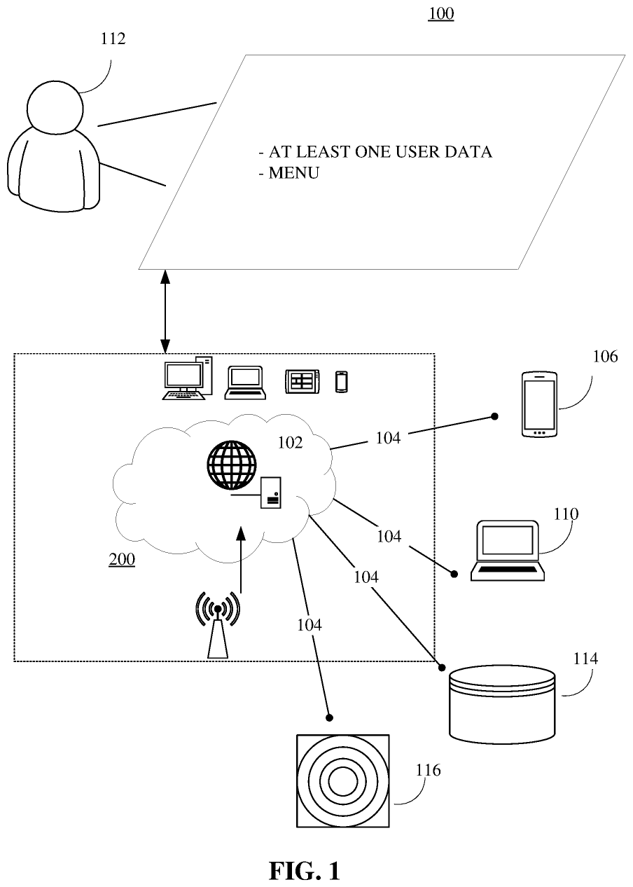

FIG. 1 is an illustration of an online platform 100 consistent with various embodiments of the present disclosure. By way of non-limiting example, the online platform 100 may be hosted on a centralized server 102, such as, for example, a cloud computing service. The centralized server 102 may communicate with other network entities, such as, for example, a mobile device 106 (such as a smartphone, a laptop, a tablet computer, etc.), other electronic devices 110 (such as desktop computers, server computers, etc.), databases 114, and sensors 116 over a communication network 104, such as, but not limited to, the Internet. Further, users of the online platform 100 may include relevant parties such as, but not limited to, end-users, administrators, chefs, recipe creators, cookbook authors, influencers, restaurants, and meal delivery service providers and so on. Accordingly, in some instances, electronic devices operated by the one or more relevant parties may be in communication with the platform.

A user 112, such as the one or more relevant parties, may access online platform 100 through a web based software application or browser. The web based software application may be embodied as, for example, but not be limited to, a website, a web application, a desktop application, and a mobile application compatible with a computing device 200.

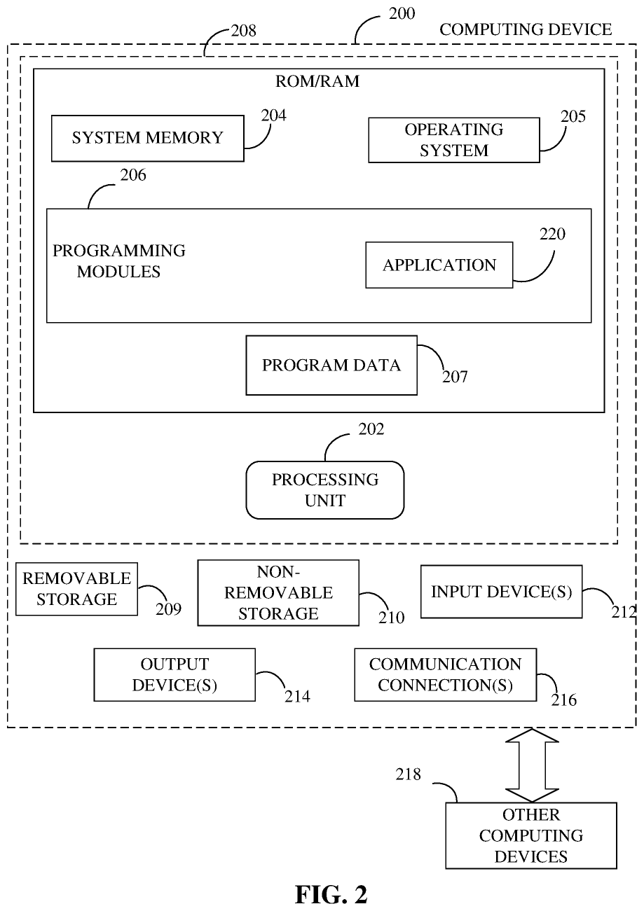

With reference to FIG. 2, a system consistent with an embodiment of the disclosure may include a computing device or cloud service, such as computing device 200. In a basic configuration, computing device 200 may include at least one processing unit 202 and a system memory 204. Depending on the configuration and type of computing device, system memory 204 may comprise, but is not limited to, volatile (e.g. random-access memory (RAM)), non-volatile (e.g. read-only memory (ROM)), flash memory, or any combination. System memory 204 may include operating system 205, one or more programming modules 206, and may include a program data 207. Operating system 205, for example, may be suitable for controlling computing device 200's operation. In one embodiment, programming modules 206 may include image-processing module, machine learning module. Furthermore, embodiments of the disclosure may be practiced in conjunction with a graphics library, other operating systems, or any other application program and is not limited to any particular application or system. This basic configuration is illustrated in FIG. 2 by those components within a dashed line 208.

Computing device 200 may have additional features or functionality. For example, computing device 200 may also include additional data storage devices (removable and/or non-removable) such as, for example, magnetic disks, optical disks, or tape. Such additional storage is illustrated in FIG. 2 by a removable storage 209 and a non-removable storage 210. Computer storage media may include volatile and non-volatile, removable and non-removable media implemented in any method or technology for storage of information, such as computer-readable instructions, data structures, program modules, or other data. System memory 204, removable storage 209, and non-removable storage 210 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 200. Any such computer storage media may be part of device 200. Computing device 200 may also have input device(s) 212 such as a keyboard, a mouse, a pen, a sound input device, a touch input device, a location sensor, a camera, a biometric sensor, etc. Output device(s) 214 such as a display, speakers, a printer, etc. may also be included. The aforementioned devices are examples and others may be used.

Computing device 200 may also contain a communication connection 216 that may allow device 200 to communicate with other computing devices 218, such as over a network in a distributed computing environment, for example, an intranet or the Internet. Communication connection 216 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 204, including operating system 205. While executing on processing unit 202, programming modules 206 (e.g., application 220 such as a media player) may perform processes including, for example, one or more stages of methods, algorithms, systems, applications, servers, databases as described above. The aforementioned process is an example, and processing unit 202 may perform other processes. Other programming modules that may be used in accordance with embodiments of the present disclosure may include machine learning applications.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, general purpose graphics processor-based systems, multiprocessor systems, microprocessor-based or programmable consumer electronics, application specific integrated circuit-based electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random-access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

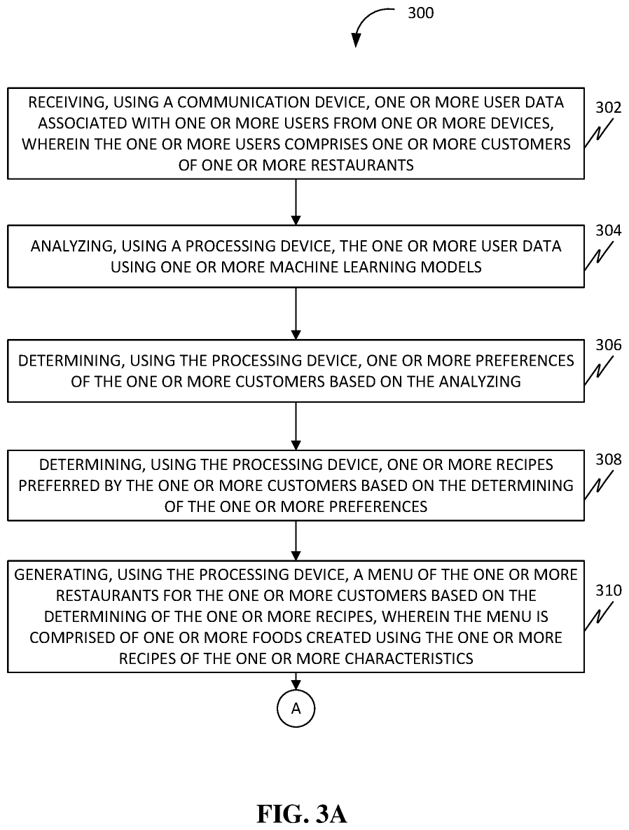

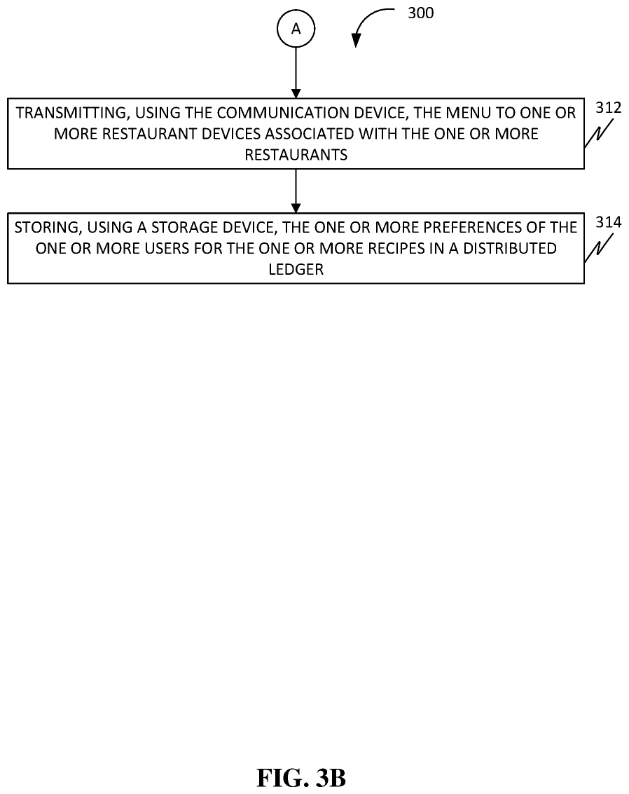

FIG. 3A and FIG. 3B illustrate a flowchart of a method 300 of personalizing services associated with restaurants for providing a marketplace for facilitating transactions, in accordance with some embodiments.

Accordingly, the method 300 may include a step 302 of receiving, using a communication device 1102, one or more user data associated with one or more users from one or more devices. Further, the one or more user data may include any information associated with the one or more users. Further, the one or more users may include individuals. Further, the one or more devices may include computing devices, client devices, etc. Accordingly, the one or more users include one or more customers of one or more restaurants. Further, the one or more restaurants may be facilities that serve food to the one or more customers. Further, the method 300 may include a step 304 of analyzing, using a processing device 1104, the one or more user data using one or more machine learning models. Further, the one or more machine learning models may be trained for detecting a degree of affinity of the one or more users towards one or more ingredients based on the one or more user data. Further, the one or more ingredients may include food ingredients, etc. Further, the affinity may be based on the characteristics (color, shape, size, texture, mouthfeel, smell, etc.) of the food ingredients. Additionally, the method 300 may include a step 306 of determining, using the processing device 1104, one or more preferences of the one or more customers based on the analyzing. Further, the one or more preferences may include one or more selection parameters for selecting one or more of the one or more ingredients. Further, the one or more selection parameters may include a taste, a color, a texture, a smell, a type (plant-based, animal-based, etc.), an appearance, etc. of the one or more ingredients, Also, the method 300 may include a step 308 of determining, using the processing device 1104, one or more recipes preferred by the one or more customers based on the determining of the one or more preferences. Further, the one or more recipes may include cooking recipes. Further, the one or more recipes may be created using one or more of the one or more ingredients. Further, the method 300 may include a step 310 of generating, using the processing device 1104, a menu of the one or more restaurants for the one or more customers based on the determining of the one or more recipes. Accordingly, the menu may be comprised of one or more foods created using the one or more recipes. Additionally, the method 300 may include a step 312 of transmitting, using the communication device 1102, the menu to one or more restaurant devices associated with the one or more restaurants. Further, the one or more restaurant devices may include computing devices, client devices, etc. Also, the method 300 may include a step 314 of storing, using a storage device 1106, the one or more preferences of the one or more users for the one or more recipes in a distributed ledger. Further, the distributed ledger may be associated with a blockchain.

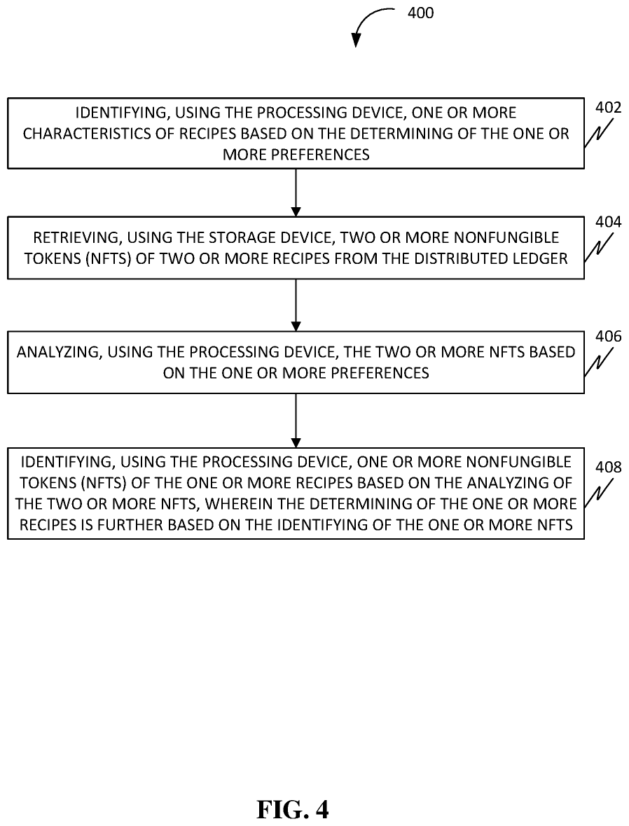

FIG. 4 illustrates a flowchart of a method 400 of personalizing services associated with restaurants for providing a marketplace for facilitating transactions, in accordance with some embodiments.

Moreover, the method 400 further may include a step 402 of identifying, using the processing device 1104, one or more characteristics of recipes based on the determining of the one or more preferences. Further, the one or more characteristics of recipes uniquely may include identifiers, ingredients, type (plant-based, animal-based, etc.), etc. of the recipes Accordingly, the method 400 further may include a step 404 of retrieving, using the storage device 1106, two or more nonfungible tokens (NFTs) of two or more recipes from the distributed ledger. Furthermore, the method 400 may include a step 406 of analyzing, using the processing device 1104, the two or more NFTs based on the one or more preferences. Moreover, the method 400 further may include a step 408 of identifying, using the processing device 1104, one or more nonfungible tokens (NFTs) of the one or more recipes based on the analyzing of the two or more NFTs. Also, the determining of the one or more recipes may be further based on the identifying of the one or more NFTs.

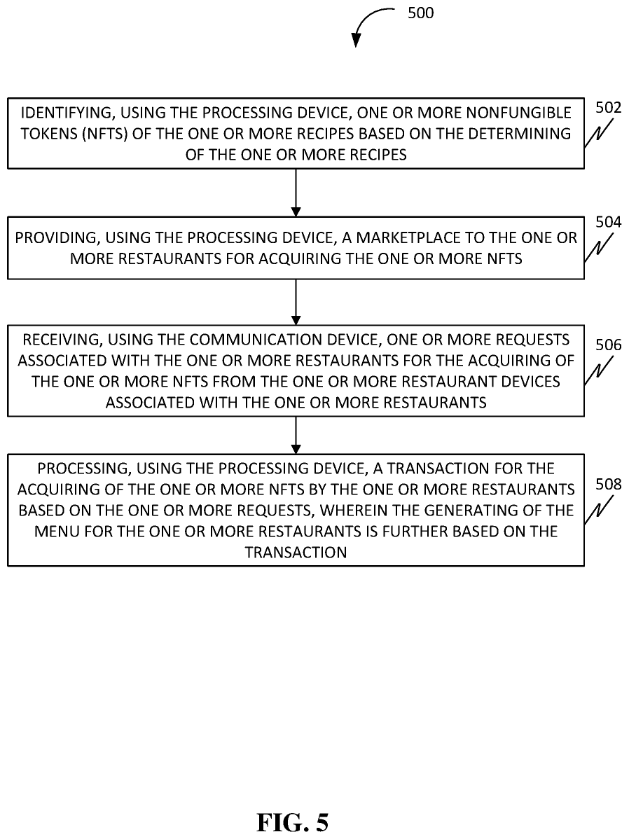

FIG. 5 illustrates a flowchart of a method 500 of personalizing services associated with restaurants for providing a marketplace for facilitating transactions, in accordance with some embodiments.

Additionally, the method 500 further may include a step 502 of identifying, using the processing device 1104, one or more nonfungible tokens (NFTs) of the one or more recipes based on the determining of the one or more recipes. Further, the one or more recipes may be created into the one or more NFTs. Also, the method 500 may include a step 504 of providing, using the processing device 1104, a marketplace (online marketplace) to the one or more restaurants for acquiring the one or more NFTs. Further, the acquiring may include purchasing, renting, leasing, etc. Further, the method 500 further may include a step 506 of receiving, using the communication device 1102, one or more requests associated with the one or more restaurants for the acquiring of the one or more NFTs from the one or more restaurant devices associated with the one or more restaurants. Further, the one or more requests may include an indication of the one or more NFTs and a payment information for making a payment for the one or more NFTs for the acquiring of the one or more NFTs. Additionally, the method 500 further may include a step 508 of processing, using the processing device 1104, a transaction for the acquiring of the one or more NFTs by the one or more restaurants based on the one or more requests. Moreover, the generating of the menu for the one or more restaurants may be based on the transaction.

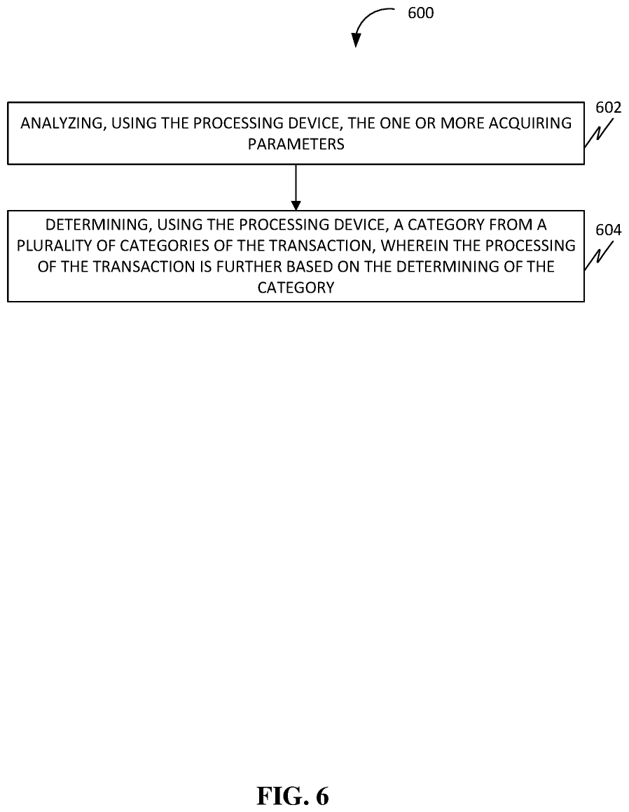

FIG. 6 illustrates a flowchart of a method 600 of personalizing services associated with restaurants for providing a marketplace for facilitating transactions, in accordance with some embodiments.

Furthermore, the one or more requests may include one or more acquiring parameters for the acquiring of the one or more NFTs. Further, the one or more acquiring parameters may include a type (such as renting, leasing, purchasing, etc.) of the acquiring, a bid for the acquiring, etc. Also, the method 600 may include a step 602 of analyzing, using the processing device 1104, the one or more acquiring parameters. Also, the method 600 may include a step 604 of determining, using the processing device 1104, a category from two or more categories of the transaction. Further, the two or more categories may correspond to the one or more acquiring parameters. Also, the processing of the transaction may be further based on the determining of the category.

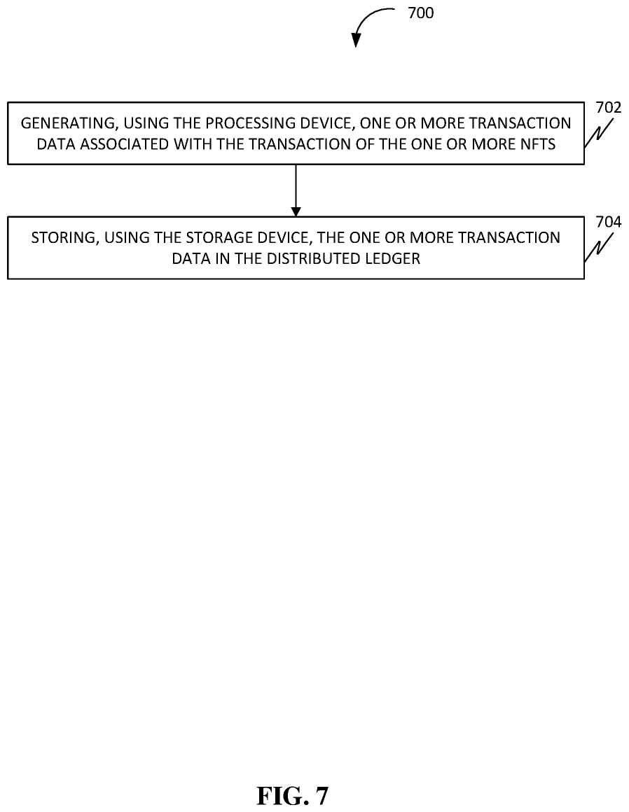

FIG. 7 illustrates a flowchart of a method 700 of personalizing services associated with restaurants for providing a marketplace for facilitating transactions, in accordance with some embodiments.

Additionally, the method 700 may include a step 702 of generating, using the processing device 1104, one or more transaction data associated with the transaction of the one or more NFTs. Further, the one or more transaction data comprises a date, a time, a transaction amount, etc. of the transaction, a previous owner, a current owner, a provenance, etc., of the one or more NFTs after the transaction, etc. Also, the method 700 further may include a step 704 of storing, using the storage device 1106, the one or more transaction data in the distributed ledger.

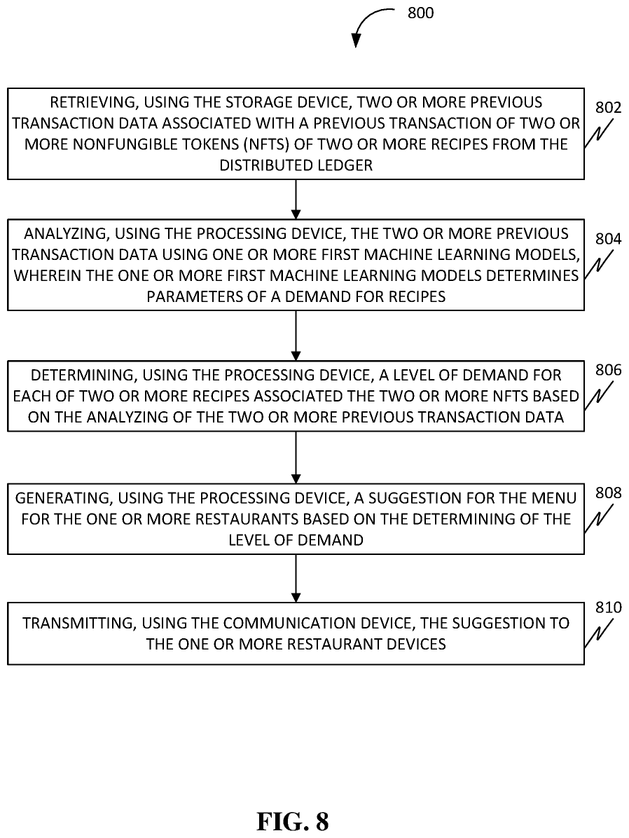

FIG. 8 illustrates a flowchart of a method 800 of personalizing services associated with restaurants for providing a marketplace for facilitating transactions, in accordance with some embodiments.

Moreover, the method 800 may include a step 802 of retrieving, using the storage device 1106, two or more previous transaction data associated with a previous transaction of two or more nonfungible tokens (NFTs) of two or more recipes from the distributed ledger. Accordingly, the method 800 may include a step 804 of analyzing, using the processing device 1104, the two or more previous transaction data using one or more first machine learning models. Further, the one or more first machine learning models determine parameters of a demand for recipes. Further, the parameters of the demand for the recipes may include transactions amount, a number of transactions for the acquiring, current owners, etc., of the two or more NFTs. Furthermore, the method 800 further may include a step 806 of determining, using the processing device 1104, a level of demand for each of two or more recipes associated with the two or more NFTs based on the analyzing of the two or more previous transaction data. Moreover, the method 800 further may include a step 808 of generating, using the processing device 1104, a suggestion for the menu for the one or more restaurants based on the determining of the level of demand. Accordingly, the method 800 further may include a step 810 of transmitting, using the communication device 1102, the suggestion to the one or more restaurant devices.

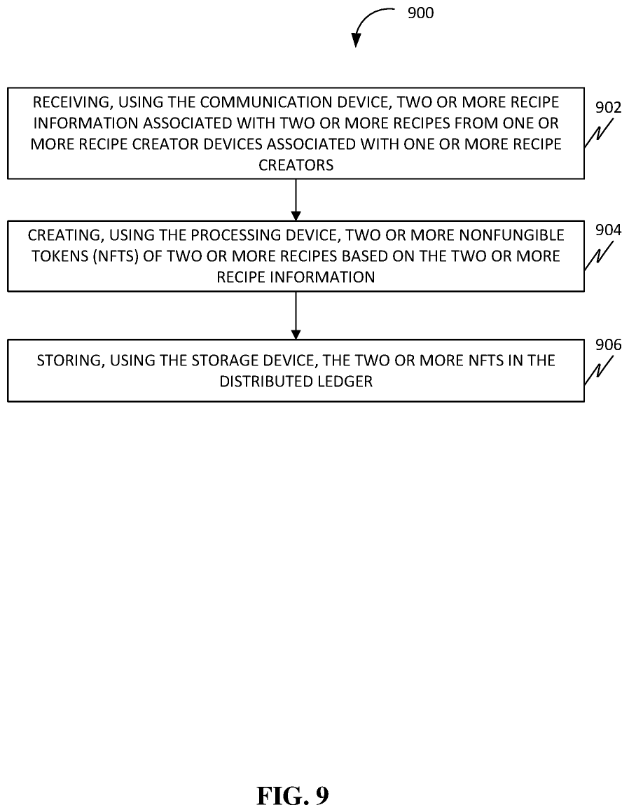

FIG. 9 illustrates a flowchart of a method 900 of personalizing services associated with restaurants for providing a marketplace for facilitating transactions, in accordance with some embodiments.

Also, the method 900 further may include a step 902 of receiving, using the communication device 1102, two or more recipe information associated with two or more recipes from one or more recipe creator devices (such as one or more recipe creator devices 1206) associated with one or more recipe creators. Further, the two or more recipe information may include a textual content, a visual content, an audio content, a multimedia content, etc. of the two or more recipes. Further, the two or more recipe information describes ingredients and instructions associated with the ingredients of the two or more recipes. Further, the two or more recipe creators may include individuals, institutions, organizations, etc., that had created the two or more recipes. Further, the two or more recipe creator devices may include computing devices, client devices, etc. Further, the method 900 further may include a step 904 of creating, using the processing device 1104, two or more nonfungible tokens (NFTs) of two or more recipes based on the two or more recipe information. Further, the creating may include minting the two or more NFTs using two or more smart contracts. Additionally, the method 900 further may include a step 906 of storing, using the storage device 1106, the two or more NFTs in the distributed ledger.

In some embodiments, the creating of the two or more nonfungible tokens (NFTs) of the two or more recipes includes creating the two or more nonfungible tokens (NFTs) of the two or more recipes according to ERC721 standard.

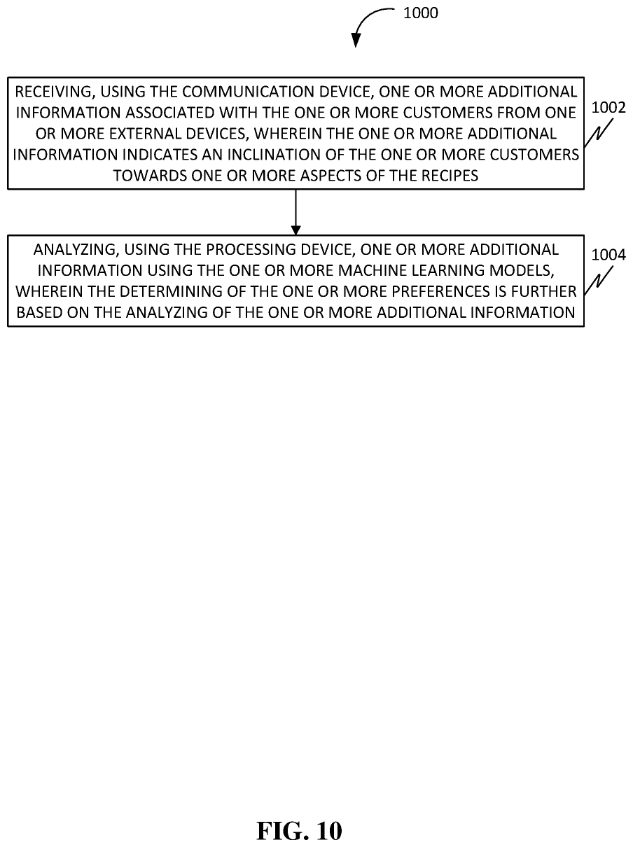

FIG. 10 illustrates a flowchart of a method 1000 of personalizing services associated with restaurants for providing a marketplace for facilitating transactions, in accordance with some embodiments.

Also, the method 1000 may include a step 1002 of receiving, using the communication device 1102, one or more additional information associated with the one or more customers from one or more external devices. Further, the or more additional information may include an activity of the one or more customers in the marketplace, a metaverse platform, a social media platform, etc. Further, the or more external devices may include data sources, servers, computing devices, client devices, etc. Further, the receiving of the one or more additional information may be based on the one or more requests. Further, the one or more requests may include identifiers for uniquely identifying the one or more customers. Furthermore, the one or more additional information indicates an inclination of the one or more customers towards one or more aspects of the recipes. Further, the one or more aspects may include a type of ingredients, a color of ingredients, a texture of ingredients, a mouthfeel of ingredients, etc., of the recipes. Further, the method 1000 further may include a step 1004 of analyzing, using the processing device 1104, one or more additional information using the one or more machine learning models. Furthermore, the determining of the one or more preferences may be further based on the analyzing of the one or more additional information.

In some embodiments, the one or more devices further includes one or more sensors. Also, the one or more sensors may be configured for generating one or more sensor data based on detecting one or more customer characteristics associated with the one or more customers. Also, the one or more user data includes the one or more sensor data. Further, the one or more sensors may include a location sensor, a physiological sensor, an imaging sensor, etc. Further, the one or more customer characteristics may include a geolocation, a physiological state, ethnicity, age, etc., of the one or more customers.

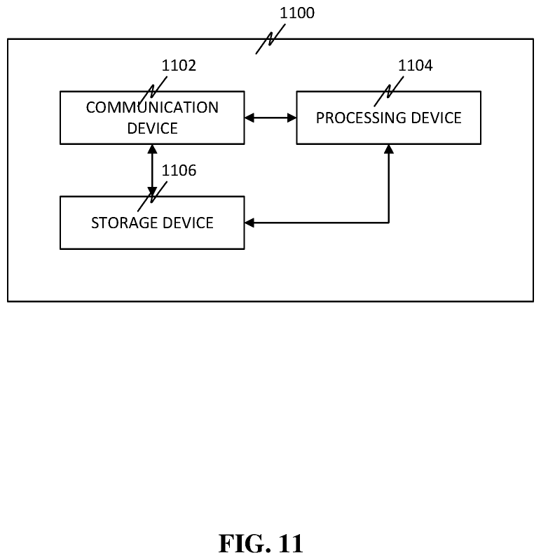

FIG. 11 illustrates a block diagram of a system 1100 of personalizing services associated with restaurants for providing a marketplace for facilitating transactions, in accordance with some embodiments.

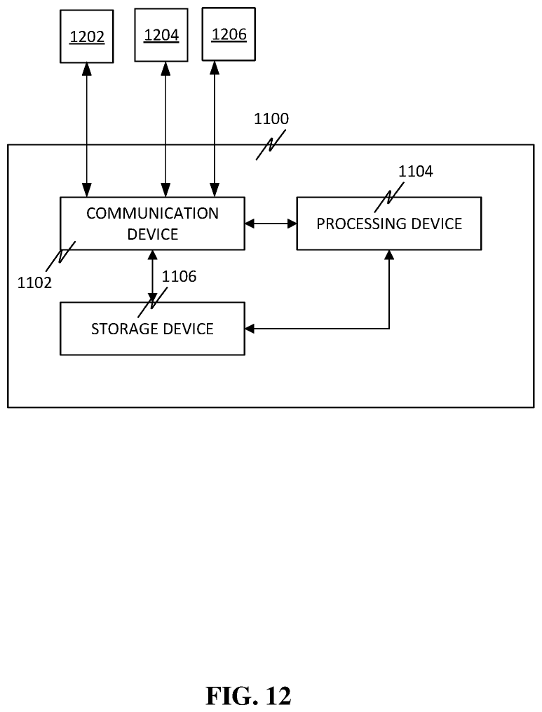

Accordingly, the system 1100 may include a communication device 1102 configured for receiving one or more user data associated with one or more users from one or more devices 1202 (as shown in FIG. 12). Accordingly, the one or more users includes one or more customers of one or more restaurants. Accordingly, the communication device 1102 may be configured for transmitting a menu to one or more restaurant devices 1204 (as shown in FIG. 12) associated with the one or more restaurants. Further, the system 1100 may include a processing device 1104 communicatively coupled with the communication device 1102. Additionally, the processing device 1104 may be configured for analyzing the one or more user data using one or more machine learning models. Also, the processing device 1104 may be configured for determining one or more preferences of the one or more customers based on the analyzing. Further, the processing device 1104 may be configured for determining one or more recipes preferred by the one or more customers based on the determining of the one or more preferences. Additionally, the processing device 1104 may be configured for generating the menu of the one or more restaurants for the one or more customers based on the determining of the one or more recipes. Accordingly, the menu may be comprised of one or more foods created using the one or more recipes. Also, the system 1100 may include a storage device 1106 communicatively coupled with the processing device 1104. Accordingly, the storage device 1106 may be configured for storing the one or more preferences of the one or more users for the one or more recipes in a distributed ledger.

Moreover, the processing device 1104 may be configured for identifying one or more characteristics of recipes based on the determining of the one or more preferences. Accordingly, the processing device 1104 may be further configured for analyzing two or more NFTs based on the one or more preferences. Furthermore, the processing device 1104 may be configured for identifying one or more nonfungible tokens (NFTs) of the one or more recipes based on the analyzing of the two or more NFTs. Additionally, the determining of the one or more recipes may be further based on the identifying of the one or more NFTs. Additionally, the storage device 1106 may be configured for retrieving the two or more nonfungible tokens (NFTs) of two or more recipes from the distributed ledger.

Further, in some embodiments, the processing device 1104 may be configured for identifying one or more nonfungible tokens (NFTs) of the one or more recipes based on the determining of the one or more recipes. Additionally, the processing device 1104 may be configured for providing a marketplace to the one or more restaurants for acquiring the one or more NFTs. Also, the processing device 1104 may be configured for processing, using the processing device 1104, a transaction for the acquiring of the one or more NFTs by the one or more restaurants based on one or more requests. Accordingly, the generating of the menu for the one or more restaurants may be further based on the transaction. Accordingly, the communication device 1102 may be configured for receiving the one or more requests associated with the one or more restaurants for the acquiring of the one or more NFTs from one or more restaurant devices 1204 associated with the one or more restaurants.

Moreover, in some embodiments, the one or more requests may include one or more acquiring parameters for the acquiring of the one or more NFTs. Further, the processing device 1104 may be configured for analyzing the one or more acquiring parameters. Further, the processing device 1104 may be configured for determining a category from two or more categories of the transaction. Further, the processing of the transaction may be based on the determining of the category.

In some embodiments, the processing device 1104 may be configured for generating one or more transaction data associated with the transaction of the one or more NFTs. Moreover, the storage device 1106 may be configured for storing the one or more transaction data in the distributed ledger.

Furthermore, in some embodiments, the storage device 1106 may be configured for retrieving two or more previous transaction data associated with a previous transaction of two or more nonfungible tokens (NFTs) of two or more recipes from the distributed ledger. Further, the processing device 1104 may be further configured for analyzing the two or more previous transaction data using one or more first machine learning models. Further, the one or more first machine learning models determines parameters of a demand for recipes. Further, the processing device 1104 may be configured for determining a level of demand for each of two or more recipes associated with the two or more NFTs based on the analyzing of the two or more previous transaction data. Further, the processing device 1104 may be configured for generating a suggestion for the menu for the one or more restaurants based on the determining of the level of demand. Further, the communication device 1102 may be configured for transmitting the suggestion to the one or more restaurant devices 1204.

In some embodiments, the communication device 1102 may be configured for receiving two or more recipe information associated with two or more recipes from one or more recipe creator devices 1206 (as shown in FIG. 12) associated with one or more recipe creators. Moreover, the processing device 1104 may be configured for creating two or more nonfungible tokens (NFTs) of two or more recipes based on the two or more recipe information. Moreover, the storage device 1106 may be further configured for storing the two or more NFTs in the distributed ledger.

In some embodiments, the creating of the two or more nonfungible tokens (NFTs) of the two or more recipes includes creating the two or more nonfungible tokens (NFTs) of the two or more recipes according to ERC721 standard.

In some embodiments, the communication device 1102 may be configured for receiving one or more additional information associated with the one or more customers from one or more external devices. Moreover, the one or more additional information indicates an inclination of the one or more customers towards one or more aspects of the recipes. Moreover, the processing device 1104 may be configured for analyzing one or more additional information using the one or more machine learning models. Moreover, the determining of the one or more preferences may be based on the analyzing of the one or more additional information.

In some embodiments, the one or more devices 1202 further includes one or more sensors. Further, the one or more sensors may be configured for generating one or more sensor data based on detecting one or more customer characteristics associated with the one or more customers. Further, the one or more user data includes the one or more sensor data.

FIG. 12 illustrates a block diagram of the system 1100 of personalizing services associated with restaurants for providing a marketplace for facilitating transactions, in accordance with some embodiments.

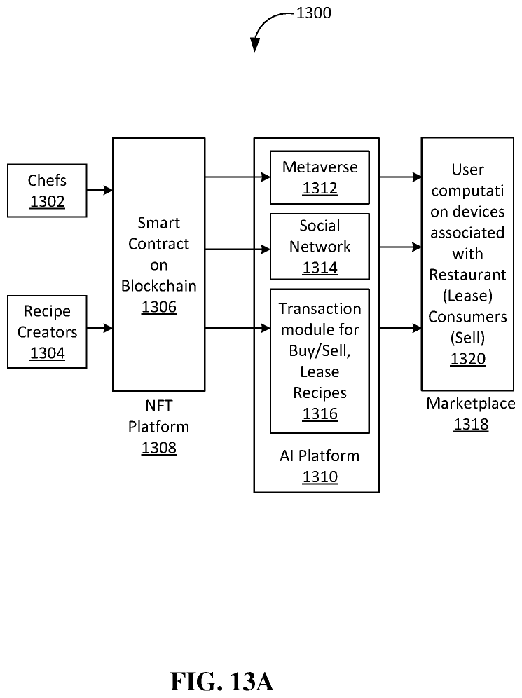

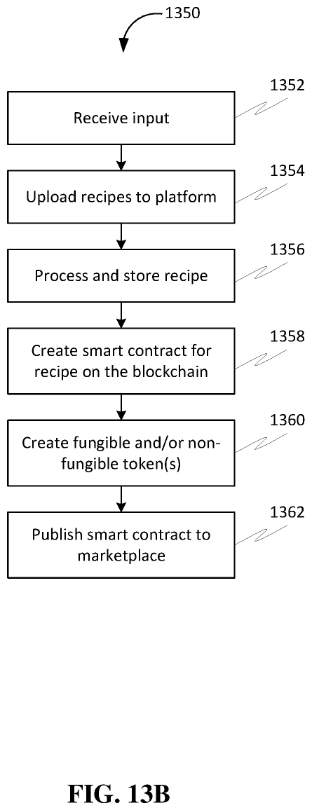

FIG. 13A shows a system 1300 for facilitating recording recipes on a blockchain and selling the recipes through a marketplace, in accordance with some embodiments. Further, the recording of the recipes on the blockchain and the selling of the recipes through the marketplace facilitates personalizing services associated with restaurants for providing the marketplace for facilitating transactions. Further, the system 1300 may include a NFT (non-fungible token) platform 1308, an AI platform 1310, and a marketplace 1318. Further, chefs and recipe creators connected to the NFT platform through computational devices 1302-1304.

Further, a plurality of chef computational devices 1302 and a plurality of recipe creator computational devices (recipe creator device) 1304 supply the recipes for being recorded through a smart contract 1306 on the blockchain, through the NFT (non-fungible token) platform 1308. Preferably recordation is performed through an interface that does not require the plurality of chef computational devices 1302 or the plurality of recipe creator computational devices 1304 to have a specific cryptocurrency wallet and/or an account at a cryptocurrency exchange. Instead, the NFT platform 1308 preferably handles recordation and other tasks required for the recipe to be recorded as an NFT on the blockchain. Once the recipe has been recorded, optionally and preferably the AI platform 1310 then performs an analysis, to locate a potential buyer or “renter” of the recipe. Further, a buyer (restaurant) of the recipe then becomes the owner of the NFT for that recipe. Further, a renter (restaurant) of the recipe receives rights to the recipe but does not become the sole owner of the corresponding NFT. Further, the AI platform 1310 optionally features a connection to one or more metaverses 1312, for example, to publicize, offer, share, buy, lease, and/or sell the NFT. Further, the AI platform 1310 preferably also supports a publication of information about the recipe, and optionally also seeks to provide information that may entice a buyer to buy the NFT representing the recipe and/or a renter of the recipe to purchase rights to access the recipe, through one or more social networks 1314. Further, the AI platform 1310 may analyze the recipe and/or associated metadata information to determine the type of user (restaurant, customer, etc.) who may be interested in purchasing or renting the recipe, for example. The AI platform 1310 may analyze information in regard to previous successful transactions for recipe purchases and/or rentals, as well as recipes that did not attract such transactions. If the creator of the recipe prefers the sale of the corresponding NFT, the AI platform 1310 also notes such a preference and seeks to interest a user in purchasing the NFT. Further, the AI platform 1310 preferably comprises one or more NLP (natural language processing) algorithms to support such publicity, publication of information, and postings on social media. Further, the AI platform 1310 also preferably features a transaction module 1316 for buying, leasing, and/or selling recipes. The previously described sale (and hence purchase by a buyer) of an NFT, as well as “renting” (leasing) the recipe, are handled through the transaction module 1316. Further, the transaction module 1316 may be in communication with one or more third-party transaction services, such as PayPal and/or Stripe, for example, to handle the purchase. Optionally the purchaser may affect the purchase directly through a cryptocurrency transaction. The buyer may choose to receive funds as cryptocurrency, fiat currency, or a combination thereof, through the transaction module 1316. Users who wish to purchase the underlying NFT, rent the recipe, and so forth, may choose to effect their purchase or other transaction directly through transaction module 1316, or alternatively may seek to buy the underlying NFT or rent the recipe through a marketplace 1318. Further, a plurality of user computational devices 1320 connects to the marketplace 1318 to perform such transactions. A sale or rental may occur directly through social network 1314, as supported through the transaction module 1316, or maybe performed through the marketplace 1318.

FIG. 13B is a flowchart of a method (process) 1350 for facilitating recording recipes on a blockchain and selling them through a marketplace, in accordance with some embodiments. Further, the method 1350 may be performed by a platform. Further, at 1352, the method 1350 may include receiving an input. Further, at 1354, the method 1350 may include uploading recipes to a platform. Further, at 1356, the method 1350 may include processing and storing the recipes. Further, at 1358, the method 1350 may include creating a smart contract for the recipes on the blockchain. Further, at 1360, the method 1350 may include creating fungible and/or non fungible tokens for the recipes. Further, at 1362, the method 1350 may include publishing the smart contract to a marketplace.

Further, in some embodiments, the process 1350 begins with receiving input at 1352, which may include identifications of one or more user devices, and/or crypto wallets. If a user does not have a crypto wallet, one may be provided at this point. At 1354, recipes, including videos, text, secrets, and other information, are preferably uploaded to a smart contract platform through a user interface. At 1356, the user triggers the creation of a smart contract on the platform (smart contract platform), preferably from a user device that contains a wallet address of the user, to support the sale of the recipes and the associated content. At 1356, the platform processes the input recipe information and content, and preferably stores these inputs in a unique data model associated with this user wallet. At 1358, the platform preferably pushes the creator's recipe as a smart contract on the blockchain by encrypting at least the secrets and optionally the entire recipe. Preferably, the user's (creator's) rules for the sale and/or lease of the recipe are encoded in the smart contracts. At 1360, again preferably through the platform, the creator optionally creates fungible tokens (for example according to ERC20) and non-fungible tokens (for example according to ERC721). The creator may also optionally set various restrictions on this creation. At 1362, the new smart contract is preferably made available on the marketplace and optionally through the Metaverse. This process 1350 converts cooking recipes into first-class crypto assets and validates assets in a unique way to improve the liquidity of assets.

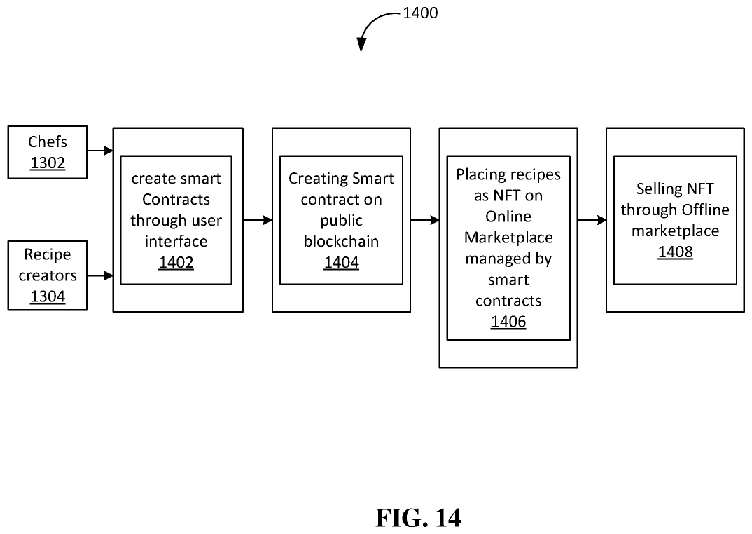

FIG. 14 is a flow diagram of a method 1400 for a recipe transaction, in accordance with some embodiments. Further, at 1402, the method 1400 may include creating smart contracts through a user interface using the plurality of chef computational devices 1302 and the plurality of recipe creator computational devices 1304. Further, at 1404, the method 1400 may include creating the smart contract on a public blockchain. Further, at 1406, the method 1400 may include placing recipes as NFT on an online marketplace managed by smart contracts. Further, at 1408, the method 1400 may include selling NFT through an offline marketplace.

Further, in some embodiments, the plurality of chef computational devices 1302 and the plurality of recipe creator computational devices 1304 supply the recipes for being recorded through a smart contract on the blockchain. For ease of transaction, preferably these computational devices send instructions to create each smart contract through a user interface, such as a web application and/or software and/or mobile app on each such computational device, at 1402. The instructions preferably include details about a recipe, whether a sale as an NFT is preferred, the cost for the purchase (and optionally for the rental), and so forth. Optionally one or more secrets or tips for creating a dish based on the recipe are included. Optionally a back story about the creator and/or the recipe may be included, for example in the form of media content, including but not limited to, audio data, video data, one or more images, and one or more text segments. Preferably details about the creator are included, such as the name, current position, restaurants worked at, and so forth. Optionally a biographical summary with further details about the creator is included. Such information may be supplied as part of the NFT or as informational content that may be published through the previously described social network. Next, at 1404, create a smart contract, preferably on a public blockchain, which codifies the NFT, NFT transactions, NFT payments, and NFT lifecycle. At 1406, the recipe, and optionally any associated information or content, preferably as an NFT, is then placed in the marketplace for purchase or rental. The marketplace is preferably online and may be accessed through the previously described user interface, a separate marketplace interface, social media, and so forth. The marketplace is preferably managed through a plurality of different smart contracts, for example, to enable both online and offline restaurants to access the recipe and associated content. Preferably, restaurants are able to use social media and/or other channels to access the online marketplace. Optionally at 1408, the recipe, and optionally any associated information or content, may be sold through an offline marketplace. However, the purchase or rental of the recipe, and optionally any associated information or content, is preferably mediated through the blockchain and the online marketplace.

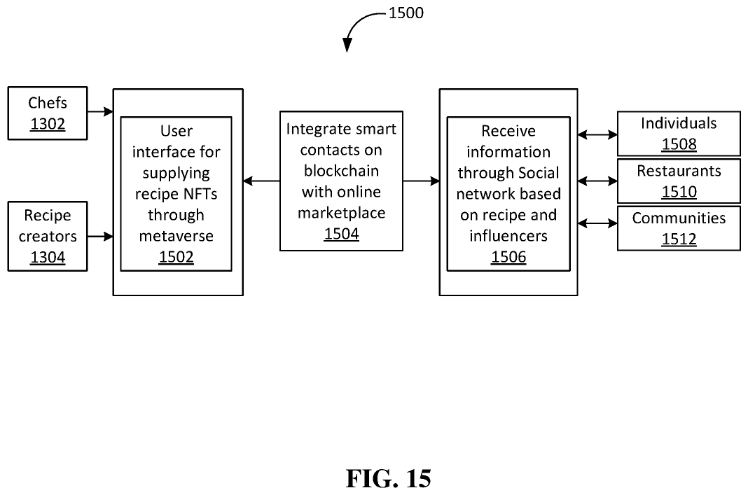

FIG. 15 is a flow diagram of a method 1500 for integrating recipe transactions with social media and the metaverse, in accordance with some embodiments. Further, at 1502, the method 1500, may include supplying NFTs through a metaverse using a user interface. Further, at 1504, the method 1500, may include integrating smart contracts on a blockchain with an online marketplace. Further, at 1506, the method 1500, may include receiving information through a social network based on recipes and influencers.

Further, in some embodiments, the plurality of chef computational devices 1302 and the plurality of recipe creator computational devices 1304 supply recipes for being recorded through a smart contract on the blockchain. Optionally recipe metadata and community data are also provided. At 1502, preferably the recipes are recorded as NFTs on the blockchain, through a smart contract platform. The smart contract platform is preferably able to supply such NFTs through the metaverse. At 1504, the smart contracts on the blockchain representing the recipes are preferably integrated with the previously described online marketplace. Such integration is preferably supported by a discovery engine at the platform (smart contract platform), which builds the collaboration data with many dimensions. The discovery engine also preferably predicts the audience for the smart contract by connecting consumers with recipe creators, and supplies such information to the online marketplace, to enable consumers to easily access the recipes of interest. At 1506, information about the recipe, one or more secrets, metadata, and associated content is preferably pushed to a social network, which may for example receive information based on recipes and influencers. Optionally, to assist in the such publication of recipes, the platform builds learning models for user preferences, location, and their community and associates with creators. The platform may also rank the recipe for given user preferences and then preferably stores the recipe (optionally with associated information) in the data model. Individuals 1508, restaurants 1510, and communities 1512, may then each access the marketplace for the recipes, smart contracts, and associated information, preferably assisted by the previously described discovery engine. Further, the method 1500 structures a discovery mechanism for the marketplace. This discovery mechanism enables the hand-shake to happen between multiple parties involved in the market, including but not limited to chefs, recipe creators, cookbook authors, consumers, and offline restaurants.

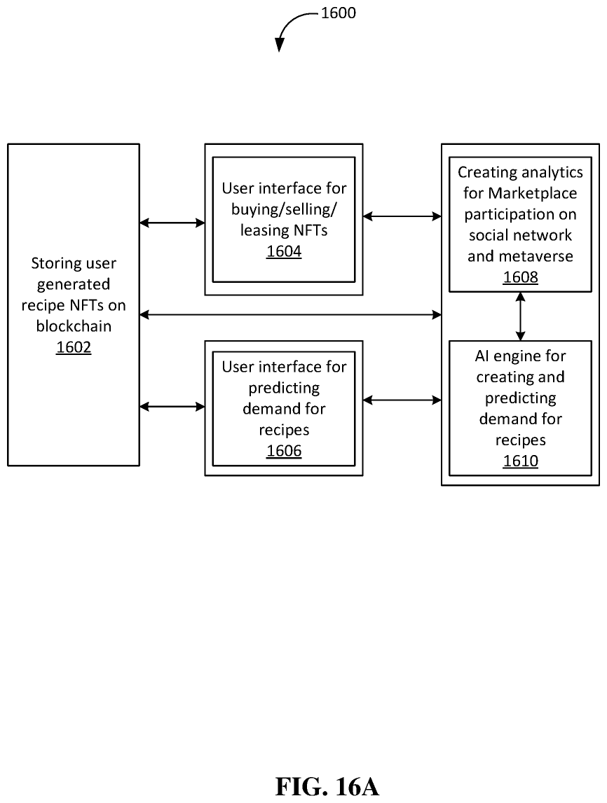

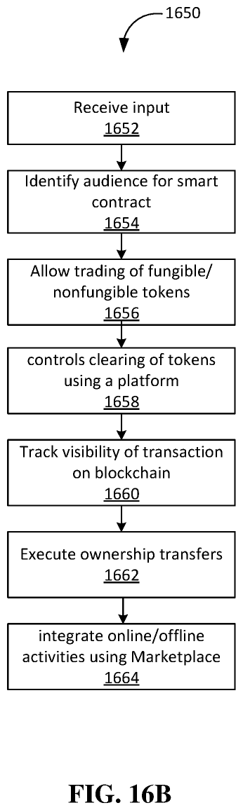

FIG. 16A is a flow diagram of a method (process) 1600 for demand prediction and sales flow, in accordance with some embodiments. Further, at 1602, the method 1600 may include storing user-generated recipe NFTs on a blockchain. Further, at 1604, the method 1600 may include buying/selling/leasing NFTs using a user interface. Further, at 1606, the method 1600 may include predicting demand for recipes using a user interface. Further, at 1608, the method 1600 may include creating analytics for marketplace participation of participants on a social network and a metaverse. Further, at 1610, the method 1600 may include creating and predicting demand for recipes using an AI engine.

Further, the process begins when user-generated recipe NFTs are stored on the blockchain at 1602. At 1604, the user may interact with the user interface to buy, sell, and/or lease NFTs. At 1606, simultaneously or sequentially, users may interact with the user interface to predict demand for recipes. At 1608, analytics may be created to assess the participation of users on the marketplace, metaverse, and/or social media, again preferably as part of the demand engine. At 1610, the AI engine ingests these analytics to predict and/or direct demand for one or more recipes.

FIG. 16B is a flow diagram of a method (process) 1650 for moderating bidding, clearing, distribution, and metadata information for facilitating the demand prediction and the sales flow, in accordance with some embodiments. Further, at 1652, the method 1650 may include receiving an input. Further, at 1654, the method 1650 may include identifying audiences for smart contracts. Further, at 1656, the method 1650 may include allowing a trading of fungible/nonfungible tokens. Further, at 1658, the method 1650 may include controlling a clearing of tokens using a platform. Further, at 1660, the method 1650 may include tracking a visibility of transactions on a blockchain. Further, at 1662, the method 1650 may include executing ownership transfers. Further, at 1664, the method 1650 may include integrating online/offline activities using a marketplace.

Further, in some embodiments, at 1652 the process begins with an input process. Such an input preferably features the creator's smart contracts, recipe metadata, and community data, which preferably are stored in the platform database. At 1654, the platform identifies the audience for the smart contract. At 1656, the platform allows fungible (ERC20) and nonfungible (ERC721) tokens to be traded on the marketplace. At 1658, the platform preferably controls the clearing and distribution of fungible and non-fungible tokens, for example, according to certain rules, regulations, or other requirements. Preferably these requirements are set through the platform. At 1660, the visibility of the entire transaction is tracked and controlled on the platform from providing party wallet addresses to receiving party wallet addresses. At 1662, according to the user action (buy/sell/lease), ownership transfers occur through the database and are also executed on the blockchain. At 1664, preferably the NFT marketplace integrates on-chain (on blockchain) activities (including Metaverse) with off-chain (not-on blockchain) activities to render this marketplace moderation. Further, the process structures the distribution and visibility of marketplace design. Further, the disclosed system integrates on-chain and off-chain activities. Further, the disclosed system also creates a new delivery mechanism for recipe assets.

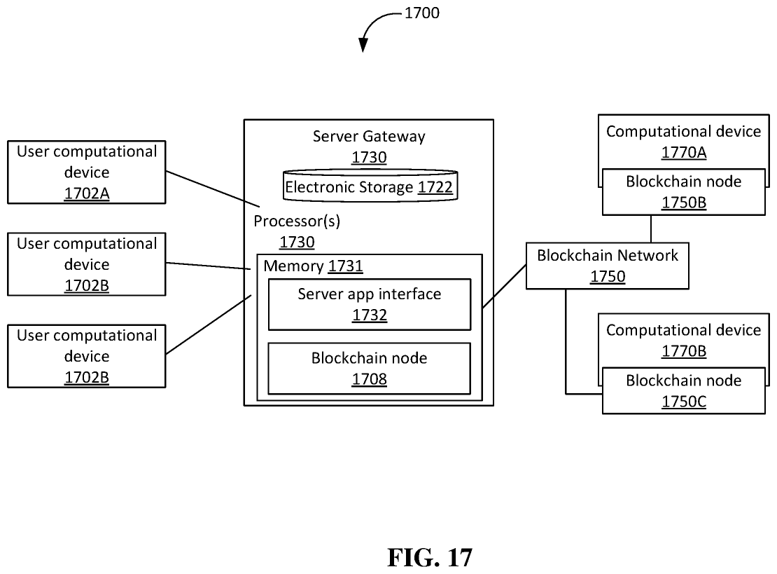

FIG. 17 is a block diagram of a blockchain-enabled system 1700 for recipe transactions, in accordance with some embodiments. Accordingly, the blockchain-enabled system (or system) 1700 may include a plurality of user computational devices 1702A and 1702B for buying, selling, and/or leasing recipes, in communication with a server gateway 1720. The server gateway 1720 is in communication with a blockchain network 1750, which may comprise one or more blockchains and/or sidechains. Computational devices 1770A and 1770B are also in communication with blockchain network 1750 through blockchain nodes 1750B and 1750C. The server gateway 1720 may be able to write directly to, and read directly from, the blockchain network 1750 through a blockchain node 1708 as shown, or alternatively may be in communication with a blockchain bridge (not shown). In either case, the server gateway 1720 may be preferably able to read information from and write information to, blockchain network 1750, including but not limited to recipes, recipe metadata, associated content, recipe secrets, and so forth. The server gateway 1720 may be preferably also able to write information to blockchain network 1750 to enable one or more smart contracts. Optionally one or more of the one or more user computational devices 1702A-1702C provide recipes and optionally associated content, secrets, metadata, and so forth, for example for sale through the previously described marketplace. Further, the server gateway 1720 may support such marketplace functions, enabling sale of the recipe and other optional information through the marketplace, for example as an NFT. Further, the server gateway 1720 preferably comprises processor 1730 and a memory 1731 with machine-readable instructions to support functions of server gateway 1720 as described herein. Also optionally, the memory 1731 may be configured for storing a defined native instruction set of codes. Further, the processor 1730 may be configured to perform a defined set of basic operations in response to receiving a corresponding basic instruction selected from the defined native instruction set of codes stored in the memory 1731. For example and without limitation, the memory 1731 may store the first set of machine codes selected from the native instruction set for receiving a recipe and/or associated information from the user computational device 1702, and the second set of machine codes selected from the native instruction set for executing functions to write the recipe to the blockchain network 1750 as an NFT, for example. Functions of the processor 1730 preferably relate to those performed by any suitable computational processor, which generally refers to a device or combination of devices having circuitry used for implementing the communication and/or logic functions of a particular system. For example, a processor may include a digital signal processor device, a microprocessor device, various analog-to-digital converters, digital-to-analog converters, and other support circuits and/or combinations of the foregoing. Control and signal processing functions of the system are allocated between these processing devices according to their respective capabilities. The processor may further include functionality to operate one or more software programs based on computer-executable program code thereof, which may be stored in a memory, such as the memory 1731 in this non-limiting example. As the phrase is used herein, the processor may be “configured to” perform a certain function in a variety of ways, including, for example, by having one or more general-purpose circuits perform the function by executing particular computer-executable program code embodied in a computer-readable medium, and/or by having one or more application-specific circuits perform the function. Further, the user computational device 1702 also comprises a processor and a memory (not shown).

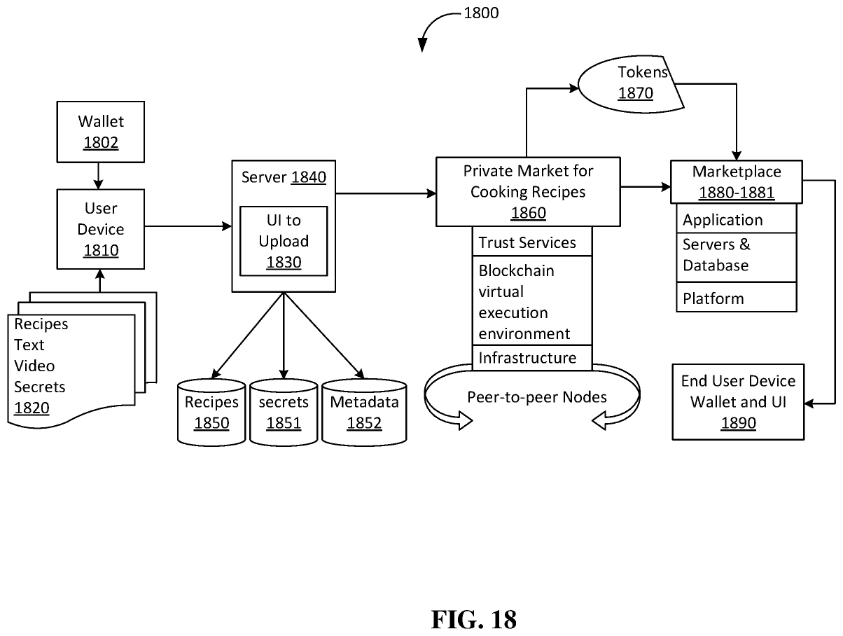

FIG. 18 is a block diagram of a system 1800 for creating a private market for cooking recipes on a blockchain, in accordance with some embodiments. Accordingly, the system 1800 may include a usage of a wallet 1802 associated with a user device 1810. Further, at 1820, the user device 1810 may receive recipes' texts, videos, and secrets. Further, the system 1800 may include a server 1840 comprising a user interface 1830 to upload. Further, the user device 1810 may be communicatively coupled with the server 1840. Further, at 1850-1852, the server 1840 may store recipes, secrets, and metadata. Further, the system 1800 may provide a private market 1860 for cooking recipes. Further, the private market 1860 may be associated with the server 1840. Further, the private market 1860 may be associated with peer-to-peer nodes. Further, the private market 1860 may be associated with trust services, blockchain virtual execution environment, and infrastructure. Further, the private market 1860 may be associated with tokens 1870. Further, the system 1800 may provide a marketplace 1880-1881 associated with the tokens 1870 and the private market 1860. Further, the marketplace 1880-1881 may be associated with an application, servers, and platform. Further, the system 1800 may include an end user device 1890 with a wallet and user interface.

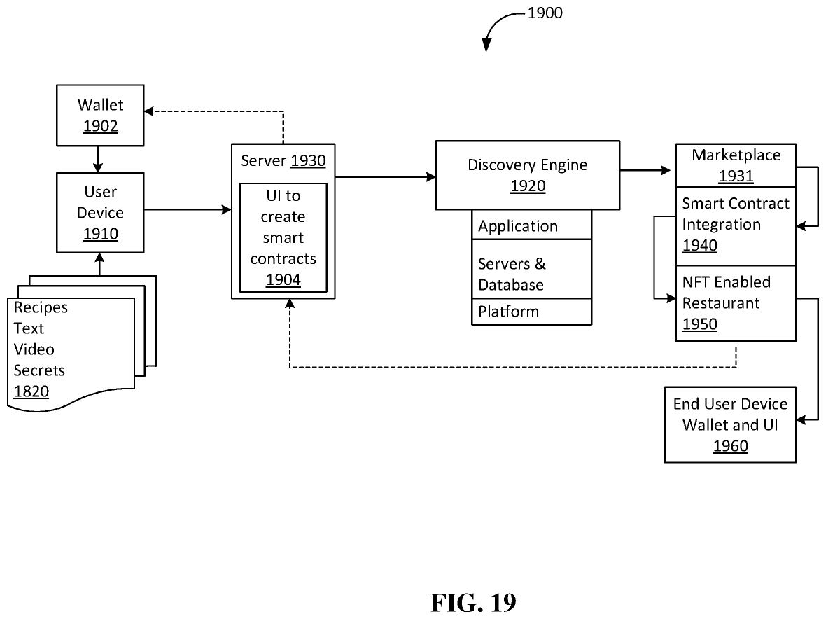

FIG. 19 is a block diagram of a system 1900 for integrating an online marketplace and offline restaurants, in accordance with some embodiments. Accordingly, the system 1900 may include a a usage of a wallet 1902 associated with a user device 1910. Further, at 1820, the user device 1910 may receive recipes' texts, videos, and secrets. Further, the system 1900 may include a server 1930 (or RMINT server) connected with the wallet 1902 and the user device 1910. Further, the server 1930 may include a user interface 1904 to create smart contracts. Further, the system 1900 may include a discovery engine 1920 associated with the server 1930. Further, the discovery engine 1920 may be associated with an application, servers and databases, and platform. Further, the system 1900 may provide a marketplace 1931. Further, the marketplace 1931 may be connected with the discovery engine 1920. Further, the marketplace 1931 may be associated with smart contract integration 1940 associated with NFT enabled restaurants 1950. Further, the NFT enabled restaurant 1950 may be associated with the UI 1904. Further, the system 1900 may include an end user device 1960 comprising a wallet and a user interface associated with the NFT enabled restaurant 1950.

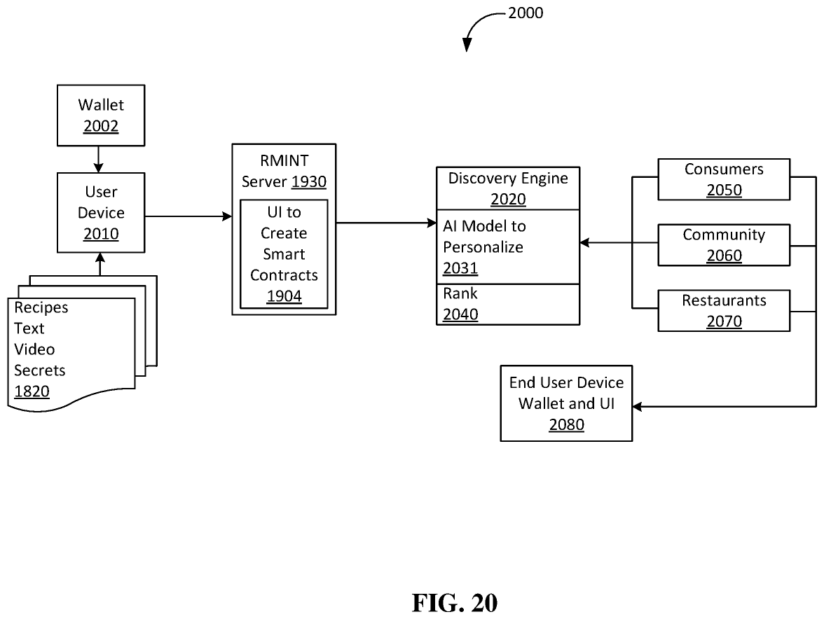

FIG. 20 is a block diagram of a system 2000 for organizing marketplace participants and networks associated with the marketplace participants, in accordance with some embodiments. Accordingly, the system 2000 may include a usage of a wallet 2002 associated with a user device 2010. Further, at 1820, the user device 2010 may receive recipes' texts, videos, and secrets. Further, the system 2000 may include a RMINT server 1930. Further, the RMINT server 1930 may include a user interface 1904 to create smart contracts. Further, the system 2000 may include a discovery engine 2020 associated with the RMINT server 2030. Further, the discovery engine 2020 may include a AI model 2031 to personalize and a rank 2040. Further, the system 2000 may include consumers 2050, community 2060, and restaurants 2070 associated with the discovery engine 2020. Further, the system 2000 may include an end user device 2080 comprising a wallet and a user interface.

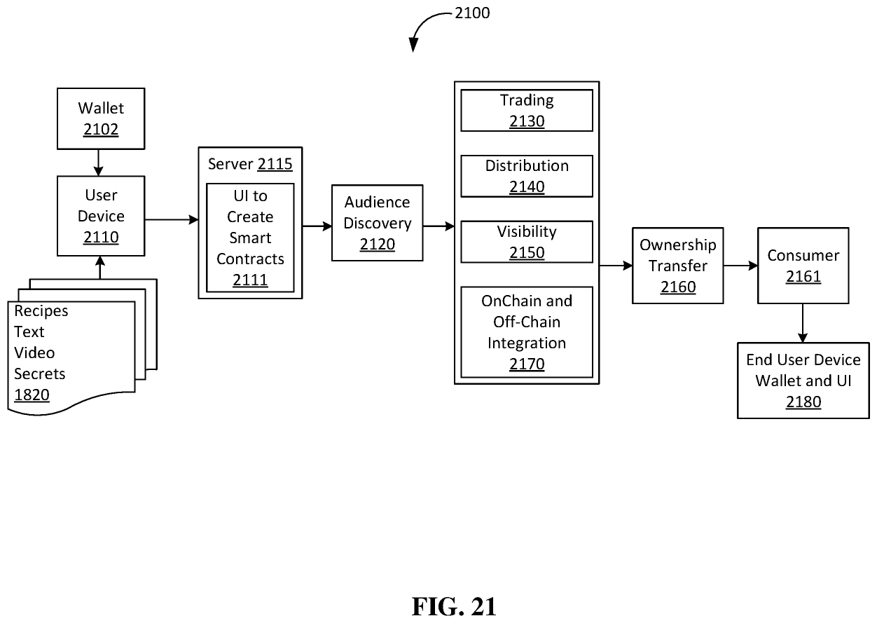

FIG. 21 is a block diagram of a system 2100 for moderating trades of recipe crypto assets, in accordance with some embodiments. Accordingly, the system 2100 may include a usage of a wallet 2102 associated with a user device 2110. Further, at 1820, the user device 2110 may receive recipes' texts, videos, and secrets. Further, the system 2100 may include a server 2115 comprising a user interface 2111 to create smart contracts. Further, the system 2100 may include an audience discovery 2120. Further, at 2130, the system 2100 may allow users to trade. Further, at 2140, the system 2100 may be configured for facilitating distribution. Further, at 2150, the audience discovery may be associated with a visibility. Further, at 2170, the system 2100 may be configured for on chain and off chain integration. Further, at 2160, the system 2100 may be configured for ownership transfer. Further, the system 2100 may include an end user device 2180 comprising a wallet and a user interface.

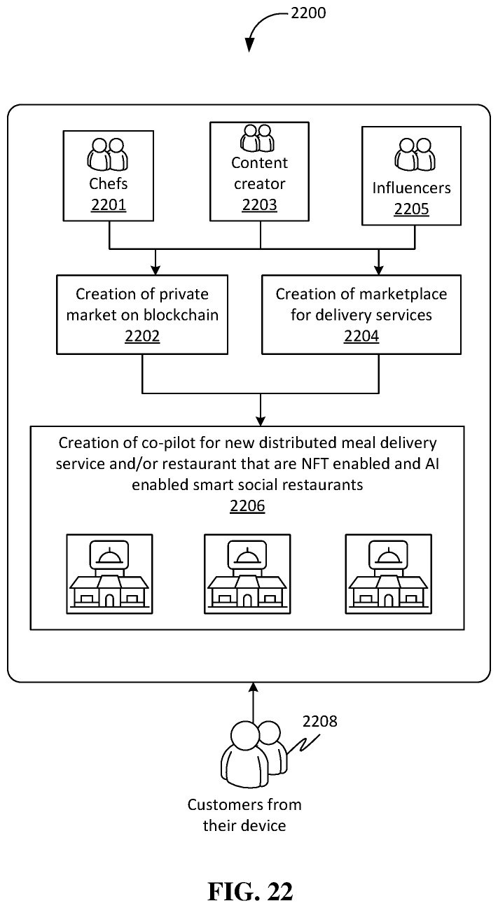

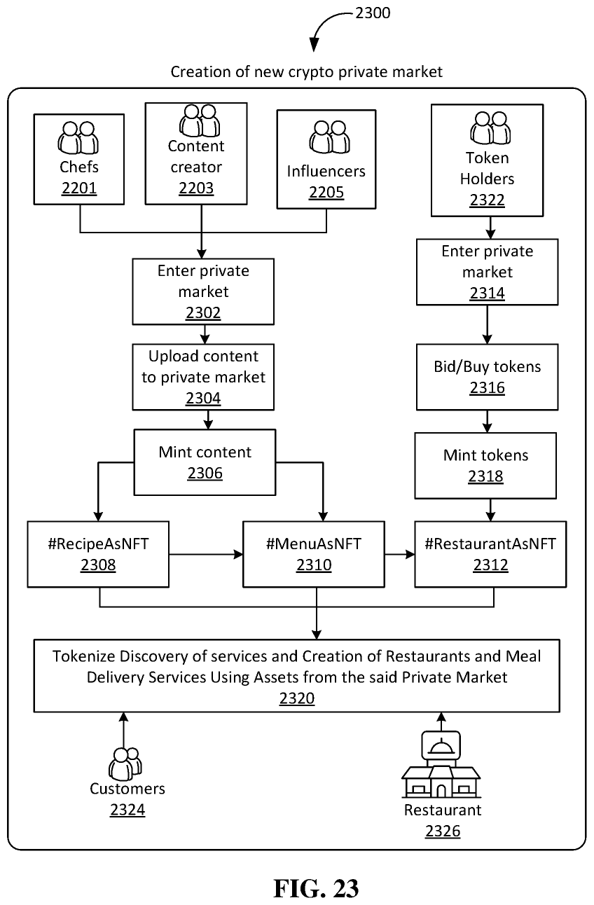

FIG. 22 is a flow diagram of a method 2200 for creating a new private market and a marketplace for cooking recipes on a blockchain, in accordance with some embodiments. Further, at 2202, the method 2200 may include creating a private market one a blockchain. Further, at 2204, the method 2200 may include creating a marketplace for delivery services. Further, after 2202 and 2204, the method 2200 may include creating a co-pilot for new distributed meal delivery services and/or restaurants that are NFT enabled and AI enabled smart social restaurants.

Further, the method 2200 may be associated with the disclosed system. Further, the private market, as shown in step 2202, creates a new kind of marketplace to deliver new kinds of services, as shown in step 2204. New kinds of services that are created from the marketplace help to create new kinds of distributed meal delivery services and restaurants, as shown in FIG. 23 and step 2206. Further, the private market, shown in step 2202, allows chefs, recipe creators, cookbook authors, influencers, restaurants, and meal delivery services to trade their services without a middleman. As a consequence of the private market, as shown in step 2202, the creation of a new marketplace is allowed, as shown in step 2204. This new marketplace allows assets and services to be transacted thru various smart contracts. This new transaction mechanism allows new kinds of assets and new kinds of services in the marketplace, as shown in step 2204. As a consequence of the new transaction mechanism, a new category of distributed and autonomous restaurants and delivery services are created, as shown in step 2206. This new transaction mechanism creates a new king of NFT-enabled and AI-enabled restaurants and delivery services. Further, consumers can access the entire capabilities of this disclosed system from consumers' devices 2208. Further, chefs, content creators, and influencers may engage with steps 2202-2204 using devices (2201, 2203, and 2205).

FIG. 23 is a flow diagram of a method 2300 for creating a new crypto private market, in accordance with some embodiments. Further, at 2302, the method 2300 may include entering a private market by the chefs, the content creators, and the influencers using the devices (2201, 2203, 2205). Further, at 2304, the method 2300 may include uploading content to the private market. Further, at 2306, the method 2300 may include minting content. Further, at 2308, the method 2300 may include generating #RecipeAsNFT. Further, at 2310 after the step 2308 and 2306, the method 2300 may include generating #MenuAsNFT. Further, at 2314, the method 2300 may include entering the private market by token holder using device 2322. Further, at 2316, the method 2300 may include bidding/buying tokens. Further, at 2318, the method 2300 may include minting tokens. Further, at 2312 after the step 2318 and 2310, the method 2300 may include generating #RestaurantAsNFT. Further, at 2320 after the step 2308, 2310, and 2312, the method 2300 may include tokenizing a discovery of services and a creation of restaurants and meal delivery services using assets from the private market. Further, customers may engage with the step 2320 using a device 2324 and restaurants may engage with the step 2320 using a device 2326.

Further, in the private market, the stakeholders comprising of chefs, content creators, cookbook authors, and influencers, can enter the market and upload content comprising of videos, blogs, and cookbooks and converts them into recipes and menus as new crypto assets, as shown in steps 2302, 2304, and 2306. In the private market new class of crypto assets comprised of the recipe as NFT and menu as shown steps 2308 and 2310. In the private market, a new class of crypto assets comprising physical restaurants are tokenized, as shown in step 2312. Further, the tokenization of crypto assets is built on a unique process of the bid/buy model, which is modeled based on various token economics, as shown in step 2316. Consumers who want to know tokens in the restaurants can access the private market and bid/buy tokens that are minted for the restaurant, as shown in steps 2302, 2316, and 2318. This creates a new asset class comprising restaurants as NFT, as shown in step 2312. In the private market, the tokenization of assets creates new services that are discovered through discovery services, as shown in step 2320. This service discovers customers, stakeholders, and distributed restaurants and matches various services offered on the private market.

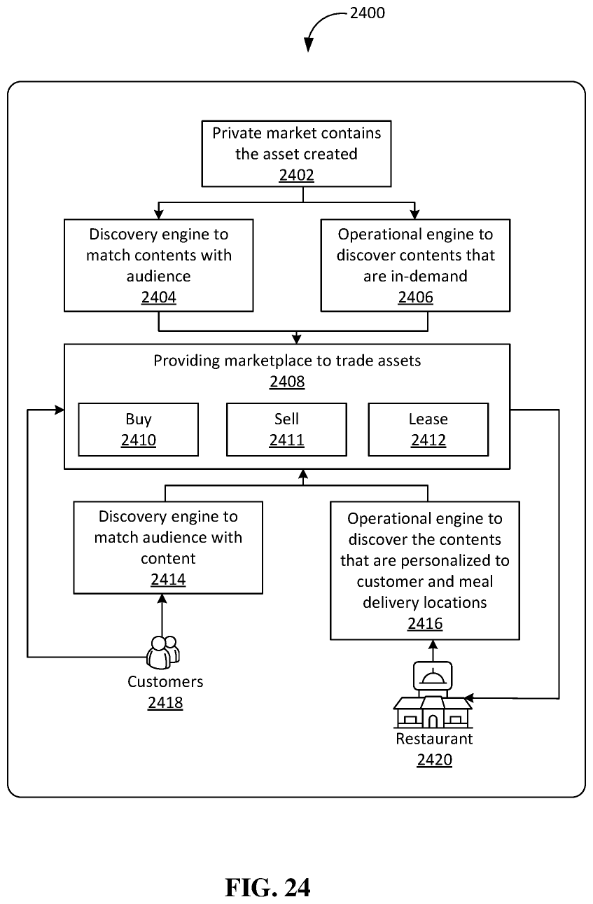

FIG. 24 is a flow diagram of a method 2400 to create a new NFT marketplace from the newly created crypto private market, in accordance with some embodiments. Further, at 2402, the method 2400 may include containing assets in the private market created in step 2204. Further, at 2404, the method 2400 may include matching contents with an audience using a discovery engine. Further, at 2406, the method 2400 may include discovering contents that are in demand using an operational engine. Further, at 2408, the method 2400 may include providing a marketplace for trading the assets. Further, the trading may include buying 2410, selling 2411, and leasing 2412. Further, at 2414, the method 2400 may include matching an audience with contents using the discovery engine. Further, at 2416, the method 2400 may include discovering the contents that are personalized to a customer and meal delivery locations using the operational engine. Further, customers may engage with steps 2414 and 2408 using a device 2418. Further, restaurants may engage with steps 2416 and 2408 using a device 2420.

Further, the new NFT marketplace may be created from the newly created crypto private market, as shown in FIG. 22, step 2402. The marketplace is the hub that connects the private market and distributed meal delivery services. Discovery engines power the marketplace to match every stakeholder in the multisided marketplace. An AI-powered discovery engine is created to match content with the audience, as shown in step 2404. Another AI-powered discovery engine is created to find an audience for the content creator and various stakeholders, as shown in step 2414. These two engines match and personalize content in the marketplace for customers and other stakeholders. Based on the recommendations from the discovery engine, customers can buy crypto assets from the marketplace, as shown in step 2410. Based on the recommendations from the discovery engine, content creators, chefs, and influencers can sell crypto assets on the marketplace, as shown in step 2411. Based on the recommendations from the discovery engine, distributed restaurants can lease the contents and know-how from the marketplace, as shown in step 2412, and pay royalties to the creators. These discovery engines, which are the backbone of the marketplace, personalize the discovery and distribution of content to various stakeholders in the marketplace. As a consequence of this personalization, another AI-powered operational engine is created to discover in-demand content in the marketplace, as shown in step 2406. As a consequence of this personalization and discovery of in-demand content, another new AI-powered operational engine is created to run the discovery of distributed restaurants that can allow consumers to experience the meal service that they want. This is a new horizon that was not possible before. This is a new immersive experience that integrates online experience to offline experience. Online can be the internet, metaverse, on any other AR/VR medium. This marketplace can extend to any medium on the internet, comprising social media, blogs, websites, and the metaverse. As a consequence of this marketplace extension, customers can buy content through any new channels, as shown in step 2410. As a consequence of this marketplace extension, chefs, content creators, and influencers can sell content through new channels, as shown in step 2411. As a consequence of this marketplace extension, distributed restaurants can lease the contents from any new channels and pay royalty, as shown in step 2412.

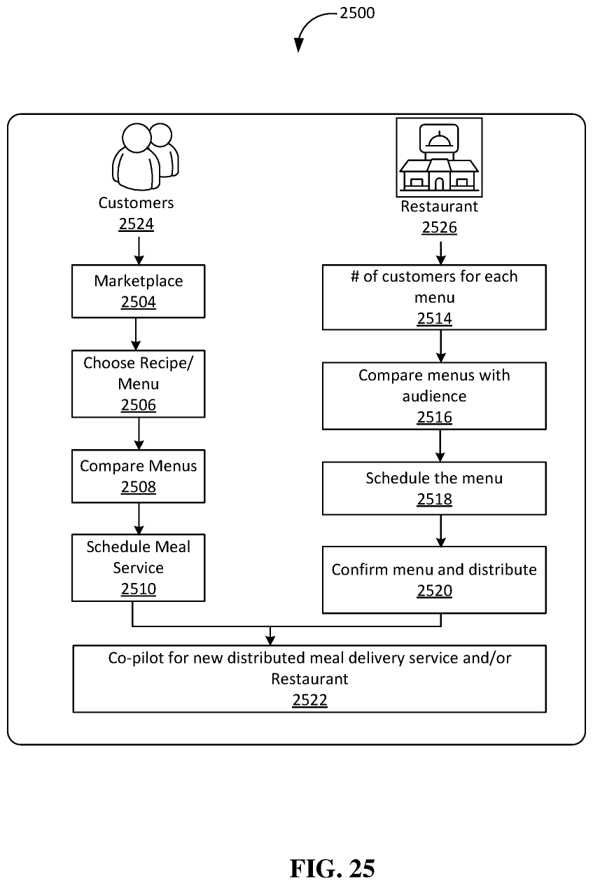

FIG. 25 is a flow diagram of a method 2500 for creating a co-pilot to run a distributed restaurant, in accordance with some embodiments. Further, at 2504, the method 2500 may include providing a marketplace to customers. Further, the customers may access the marketplace using a device 2524. Further, at 2506, the method 2500 may include choosing recipes/menus. Further, at 2508, the method 2500 may include comparing the menus. Further, at 2510, the method 2500 may include scheduling meal services. Further, at 2514, the method 2500 may include providing a number of customers for each menu to restaurants. Further, the restaurants may see the number of customers using a device 2526. Further, at 2516, the method 2500 may include comparing menus with an audience. Further, at 2518, the method 2500 may include scheduling the menu. Further, at 2520, the method 2500 may include confirming the menu and distributing the menu. Further, at 2522 after steps 2510 and 2520, the method 2500 may include using a co-pilot for new distributed delivery service and/or restaurant.

Further, the co-pilot connects the discovery services of the private market and marketplace, as shown in FIG. 22, step 2206. Further, the co-pilot is the operational intelligence to run distributed restaurants. Further, the co-pilot gathers requirements from the personalization services and distributes the customers' needs to distributed restaurants. This new horizon replaces all the old discovery services comprising yelp reviews, google Maps reviews. This new horizon directly connects customers to chefs and cooks in the distributed restaurants by bypassing all intermediaries. This new horizon brings the best customer experience to restaurants and meal delivery services. Customers can choose their choice of recipes and menus to be cooked by the distributed restaurants, as shown in step 2504. Customers can compare the recipes and menus and choose the one they like from their recommended choices, as shown in step 2508. Customers can schedule meals based on the choices of a given location of restaurants generated by an artificial intelligence engine, as shown in step 2510. Distributed restaurants can see the number of customers for each set of menus, as shown in step 2514. This allows chefs, cooks, and managers to decide which menu to choose for their restaurants that can increase the profit margin, as shown in step 2516. The chosen menu is scheduled to kick off the back office integrations for the menu, as shown in step 2518. The confirmed menu is distributed to the co-pilot to send notifications to all customers, as shown in step 2520. Co-pilot manages the operational intelligence of this process and moves the horizon of new customer experience.

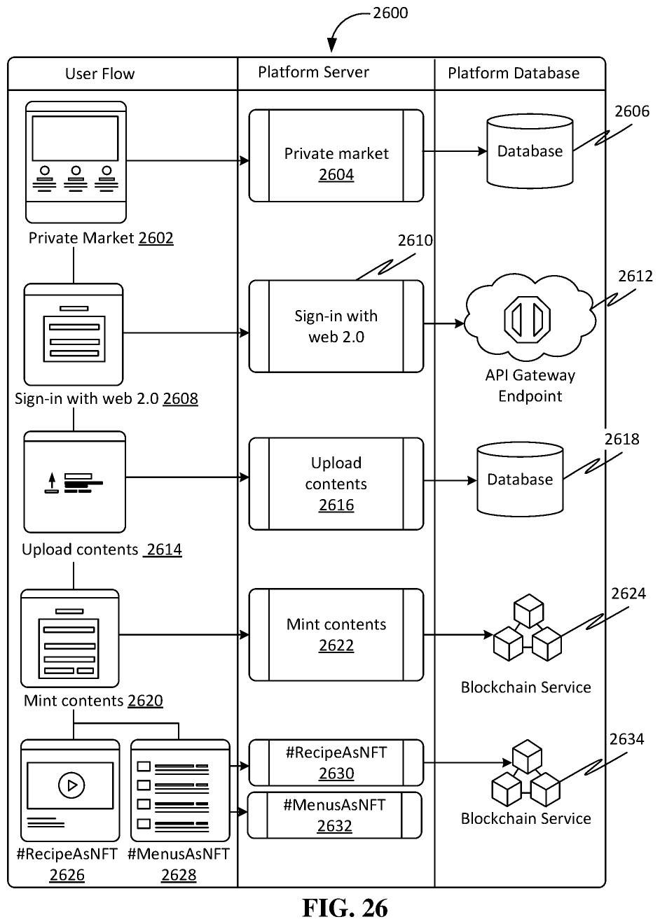

FIG. 26 is a flow diagram of a method 2600 for tokenizing content, recipes, and menus, in accordance with some embodiments. Further, the method 2600 may be performed by a platform server. Further, at 2604, the method 2600 may include allowing stakeholders comprising chefs, content creators, cookbook authors, and influencers to enter the market to create a new crypto asset class. Further, the step 2604 may be associated with a private market user interface 2602 and a database 2606 associated with a platform database.

Further, at 2610, the method 2600 may include sign-in with web 2.0. Further, the step 2610 may be associated with a sign-in with web 2.0 user interface 2608 and an API gateway endpoint 2612 associated with the platform database.

Further, at 2616, the method 2600 may include allowing the stakeholders to upload the content and convert all the offline content and online (web 2) content into the platform server, which intern stored in the platform database. Further, the step 2616 may be associated with an upload contents user interface 2614 and a database 2618 associated with the platform database.

Further, at 2622, the method 2600 may include allowing the contents to be minted on any blockchain platform and get their address back on the platform server and stored in the user's wallet. Further, the step 2622 may be associated with a mint contents user interface 2620 and a blockchain service 2624 associated with the platform database.

Further, at 2630, the method 2600 may include allowing the minted contents to be created as non-fungible tokens (NFT) or fungible tokens through various smart contracts and publish it as a recipe as NFT on blockchain services and NFT marketplaces. Further, the step 2630 may be associated with a recipe As NFT user interface 2626 and a blockchain service 2634 associated with the platform database.

Further, at 2632, the method 2600 may include allowing the minted contents to be created as non-fungible tokens (NFT) or fungible tokens through various smart contracts and publish it as Menu as NFT on the blockchain services and NFT marketplaces. Further, the step 2630 may be associated with a Menu As NFT user interface 2628 and the blockchain service 2634 associated with the platform database. These steps in the method 2600 create a new web 3.0 asset class and take ownership of the assets.

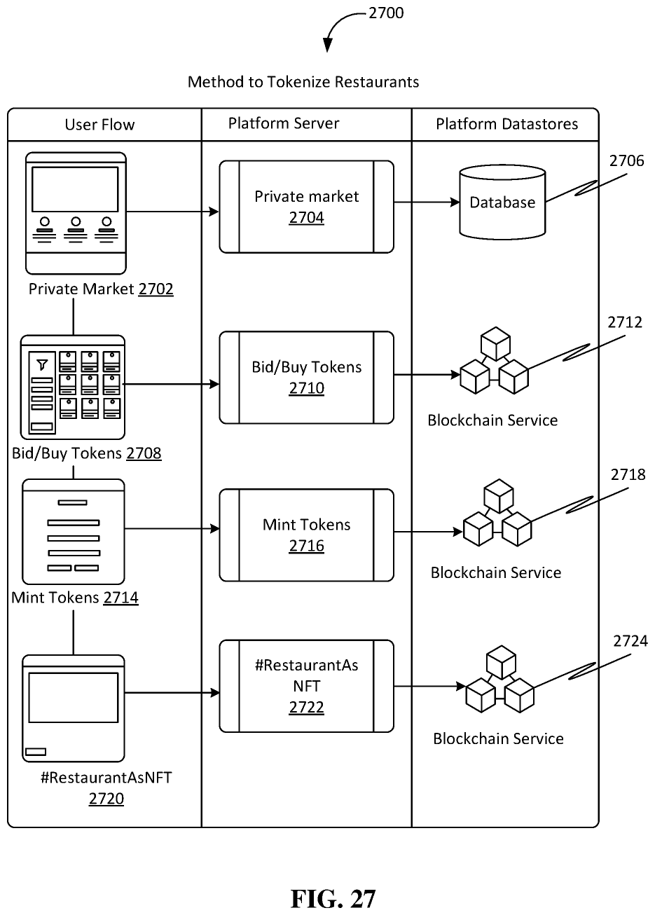

FIG. 27 is a flow diagram of a method 2700 to tokenize physical restaurants, in accordance with some embodiments. Further, the method 2700 may be performed by a platform server.

Further, at 2704, the method 2700 may include allowing future token holders to enter the private market. Further, the step 2704 may be associated with a private market user interface 2702 and a database 2706 associated with a platform datastore.

Further, at 2710, the method 2700 may include bidding and buying tokens that are created based on discovery services and matched by an artificial intelligence engine. Further, the step 2710 may be associated with a bid/buy tokens user interface 2708 and a blockchain service 2712 associated with the platform datastore.

Further, at 2716, the method 2700 may include minting new tokens for the restaurants and shown on all blockchain services. Further, the step 2716 may be associated with a mint token user interface 2714 and a blockchain service 2718 associated with the platform datastore.

Further, at 2722, the method 2700 may include converting market, physical restaurants as NFT. Creation of restaurants as NFT enhances the utility of physical restaurants and makes it possible to run autonomous restaurants. DAOs are created to incentivize the autonomous behavior of restaurants. Further, the step 2722 may be associated with a restaurant as NFT user interface 2720 and a blockchain service 2724 associated with the platform datastore.

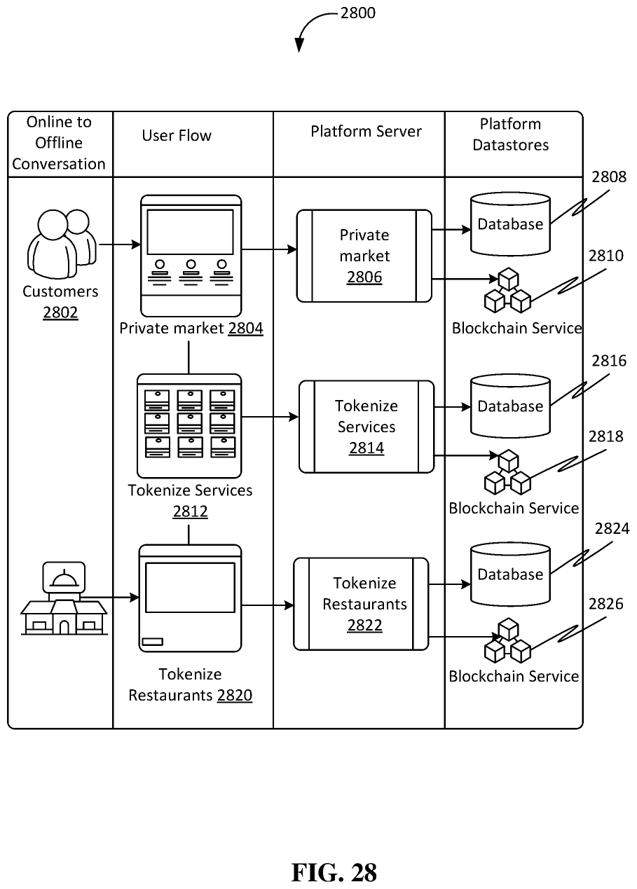

FIG. 28 is a flow diagram of a method 2800 to tokenize the discovery of new services and new kinds of restaurants and meal delivery services, in accordance with some embodiments. Further, the method 2800 may be performed by a platform server.

Further, at 2806, the method 2800 may include a customer 2802 entering a private market. Further, the step 2806 may be associated with a private market user interface 2804 and a database 2808 and a blockchain service 2810 associated with a platform datastore. As a consequence of the private market, new crypto assets such as #RecipeAsNFT and #MenusAsNFT, new capabilities are available to run distributed restaurants possible.

Further, at 2814, the method 2800 may include tokenizing services. Further, the step 2814 shows a discovery of new services. Further, the new services may be a new method for packaging recipe and menu NFTs using generative AI technology to personalize the contents to customers. Further, the new services may be a new method for allowing the customers to request meals based on recipeAsNFT and menuAsNFT contents. Further, the new services may be a new method for distributing the customer's request without any manual intervention to any distributed restaurant that is executed through smart contracts. Further, the new services may be a new method for tokenizing contents that are discovered by AI engines to individual customers. Further, the step 2814 may be associated with a tokenize services user interface 2812 and a database 2816 and a blockchain service 2818 associated with the platform datastore.

Further, at 2822, the method 2800 may include tokenization of restaurant services. Further, the tokenization of restaurant services may include creating meals based on NFT recipes and NFT menus that are personalized without human intervention through the execution of smart contacts.

Further, the tokenization of restaurant services may include leasing recipes and menus from content creators and pay appropriate royalty. Further, the tokenization of restaurant services may include getting access to the contents that are in demand in the marketplace. Further, the tokenization of restaurant services may include getting access to the contents that are discovered by an artificial intelligence engine. Further, the tokenization of restaurant services may include creating exclusivity of content to a specific set audience. Further, the tokenization of restaurant services may include running restaurant operations autonomously with AI engine and incentive tokens like NFTs and DAO. Further, the step 2822 may be associated with a tokenize restaurants user interface 2820 and a database 2824 and a blockchain service 2826 associated with the platform datastore.

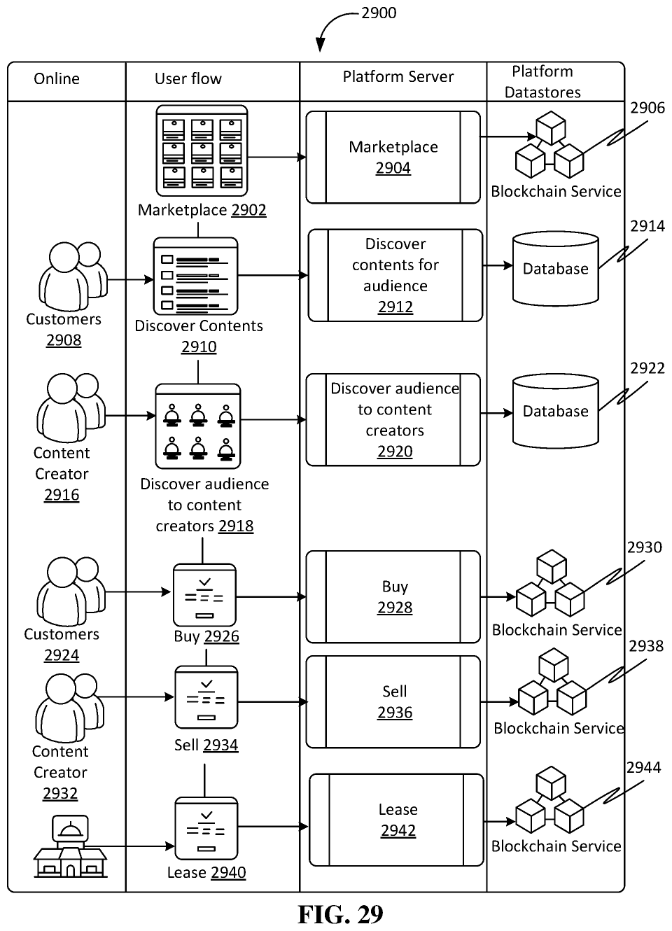

FIG. 29 is a flow diagram of a method 2900 to discover personalized content for the audience, in accordance with some embodiments. Accordingly, at 2910, the method 2900 may include a customer 2908 using a discover contents user interface. Further, at 2902, the method 2900 may include the customer 2908 using a marketplace user interface. Further, at 2904, the method 2900 may include showing the NFT marketplace on a blockchain. Further, at 2906, the method 2900 may include using a blockchain service. Further, at 2912, the method 2900 may include discovering contents for audience. Further, a discovery engine may match content to the audience from the various constraints in the platform server and platform data stores. Further, at 2914, the method 2900 may include using a database. Further, at 2918, the method 2900 may include a content creator 2916 using a discover audience user interface. Further, at 2920, the method 2900 may include the discovery engine matching the audience to content creators based on the various metrics and constraints in platform servers and platform data stores. Further, at 2922, the method 2900 may include using a database. Further, at 2926, the method 2900 may include a customer 2924 using a buy user interface. Further, at 2928, the method 2900 may include showing recommendations that the discovery engine has produced. Further, the customer 2924 may buy the contents from any online medium. Further, at 2930, the method 2900 may include using a blockchain service. Further, at 2934, the method 2900 may include a content creator 2932 using a sell user interface. Further, at 2936, the method 2900 may include showing recommendations audience that the discovery engine has discovered for content creators and chefs that sells the content to any online medium. Further, at 2938, the method 2900 may include using a blockchain service.

Further, at 2942, the method 2900 may include showing recommendations to distributed restaurants to know what customers are looking for and lease the contents from the marketplace and pay the royalty to owners of the content using a lease user interface. As a consequence of the method 2900, personalized distribution of contents is achieved that has not been done before. Further, at 2944, the method 2900 may include using a blockchain service.

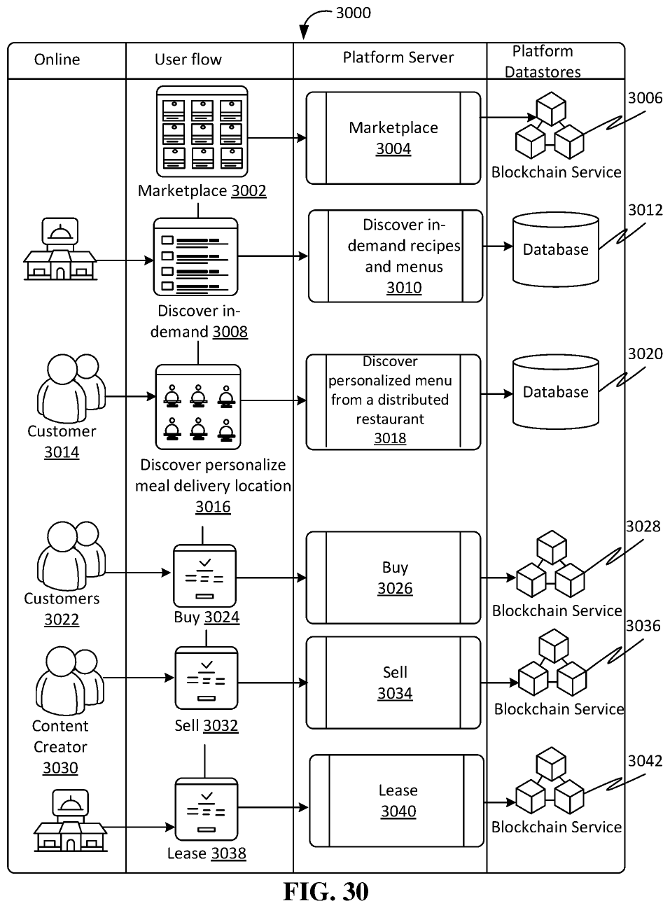

FIG. 30 is a flow diagram of a method 3000 to discover operational intelligence for distributed meal service comprising restaurants, in accordance with some embodiments. Accordingly, at 3008, the method 3000 may include a restaurant owner using a discover in demand user interface. Further, at 3002, the method 3000 may include the restaurant owner using a marketplace user interface. Further, at 3004, the method 3000 may include showing the NFT marketplace on a blockchain. Further, at 3006, the method 3000 may include using a blockchain service. Further, at 3010, the method 3000 may include discovering in demand recipes and menus. Further, at 3012, the method 3000 may include using a database. Further, the method 3000 may include discovery of operational intelligence to run distributed restaurants comprising in-demand recipes and menus. Further, at 3016, the method 3000 may include a customer 3014 using a discover personalized menu user interface. Further, at 3018, the method 3000 may include discovery of operational intelligence to run distributed restaurants comprising personalized recipes and menus for the distributed restaurant. Further, at 3020, the method 3000 may include using a database. Further, at 3024, the method 3000 may include a customer 3022 using a buy user interface. Further, at 3026, the method 3000 may include showing the recommendations to the customers that are available and that were discovered by operational intelligence in the distributed restaurants that can be bought/ordered. Further at 3028, the method 3000 may include using a blockchain service. Further, at 3030, the method 3000 may include a content creator 3030 using a sell user interface. Further, at 3034, the method 3000 may include showing the recommendations to the content creators that the audience wants and that were discovered by operational intelligence in the distributed restaurants that can be sold to the marketplace. Further at 3036, the method 3000 may include using a blockchain service. Further, at 3038, the method 3000 may include restaurant owner using a lease user interface. Further, at 3040, the method 3000 may include showing the recommendations to distributed restaurants that the audience wants and that were discovered by operational intelligence that may be leased and appropriate royalty paid back to creators. Further, new operational intelligence is created based on the discovery of a personalization engine and operational engine. This creates a new horizon for customer experience. Further at 3042, the method 3000 may include using a blockchain service.

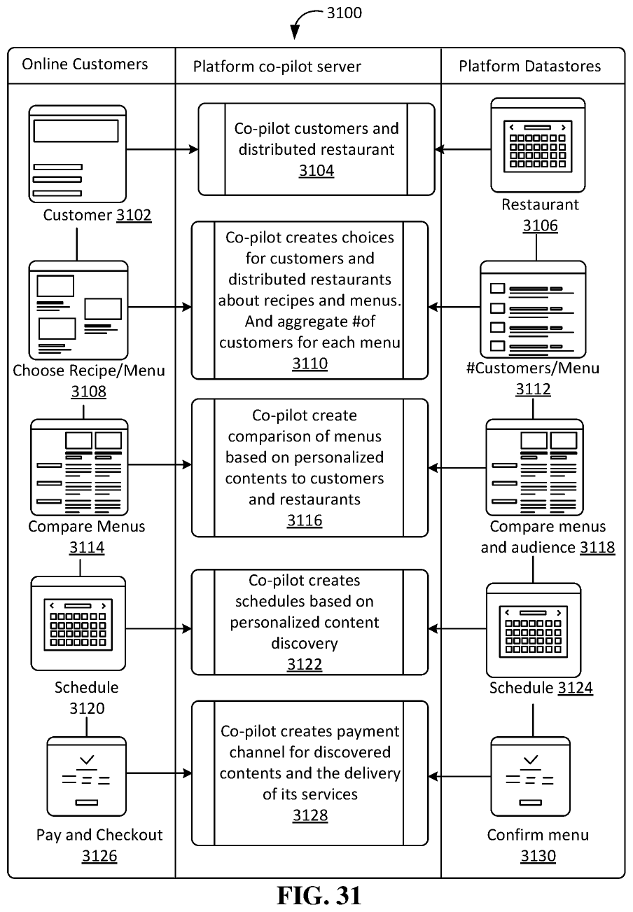

FIG. 31 is a flow chart of a method 3100 to create a co-pilot for distributed restaurants and connects it to the customers based on the discovery services from the marketplace, in accordance with some embodiments. Accordingly, at 3104, the method 3100 may include the creation of a co-pilot where customers (using a customer user interface 3102) and distributed restaurants (using a restaurant user interface 3106) work in unison to fulfill the needs of customers. Further, at 3108, the method 3100 may include online customers using a choose recipes/menu user interface. Further, at 3112, the method 3100 may include distributed restaurants using a customers/menu user interface. Further, at 3110, the method 3100 may include the creation of choices for customers and distributed restaurants. For customers, the method 3100 may include showing the personalized recipe and menu recommendation list of their choices. For restaurants, the method 3100 may include showing the number of customers available for each recipe and menu. This helps chefs and cooks choose the best menu for them.

Further, at 3114, the method 3100 may include online customers using a compare menus user interface. Further, at 3118, the method 3100 may include distributed restaurants using a compare menus and audience user interface. Further, at 3116, the method 3100 may include a comparison of recipe and menu choices for customers and distributed restaurants. For customers, the recipe and menu comparison may be based on their personalized preferences. Distributed restaurants show recipe and menu comparisons based on the operational intelligence of the co-pilot.

Further, at 3120, the method 3100 may include online customers using a schedule user interface. Further, at 3124, the method 3100 may include distributed restaurants using a schedule user interface. Further, at 3122, the method 3100 may include scheduling for customers and distribute restaurants. For customers, scheduling gives them the ability to choose a time and place to experience their choice the menu. For restaurants, scheduling gives the ability to schedule the menu for the appropriate day.

Further, at 3126, the method 3100 may include online customers using a pay and checkout user interface. Further, at 3130, the method 3100 may include distributed restaurants using a confirm menu user interface. Further, at 3128, the method 3100 may include the co-pilot creating payment channel for discovered contents and the delivery of its services. For restaurants, creating the payment channel shows the ability to receive payment through various channels. The execution excellence of this distributed operation is achieved through the operations intelligence of the co-pilot.

Further, the disclosed system may create a new private market to tokenize various—offline assets comprising recipes, videos, blogs, technical know-how, cookbooks, menus, physical restaurants in a location, virtual restaurants in the metaverse, and online digital restaurants—and convert them into crypto assets. The private market creates a new possibility of distributing, owning, sharing, and experiencing online and offline content—briefly abbreviated as DOSE—Distribute-Own-Share-Experience. Further, the marketplace may transact crypto assets that enhance the revenue potential of every stakeholder and improves customer satisfaction of customers. Personalization of the marketplace affords us a significant leap in the possibilities of various services that can be offered in this marketplace. Personalization offers the ability to create a unique experience for the customer and a set of customers. Further, the marketplace offers a means to provide personalized distribution, ownership, sharing, and experience to offline and online content—briefly abbreviated as Personalized DOSE—Personalized Distribute-Own-Share-Experience. Further, the disclosed system may include a new co-pilot engine that manages the personalization of content to customers and the personalization of content to restaurants through recipes and menus is a new horizon in meal delivery services.

Further, the new creation of a co-pilot may autonomously run operations intelligence for customers and distributed restaurant or meal delivery places. Further, the co-pilot may be a new frontier in the distribution of last-mile experiences to customers and restaurants. This creates a new operational pipeline to connect customers to restaurants' bottom line. Further, the disclosed system may provide a new kind of distributed restaurant because of all these technological breakthroughs to create new kinds of restaurants comprising NFT-enabled restaurants, AI-enabled restaurants, and AI-enabled and NFT-enabled meal delivery services, smart social restaurants. Further, a new category of tokenized restaurants that run autonomously with various incentive mechanisms, like NFTs and DAOs, pushes the new frontiers of how restaurants are financed, marketed, and operate.

Although the invention has been explained in relation to its preferred embodiment, it is to be understood that many other possible modifications and variations can be made without departing from the spirit and scope of the invention as hereinafter claimed.

### Aspects

1. A system for a secure recipe transaction through a blockchain, comprising: a recipe creator computational device, comprising a memory for storing a plurality of instructions and a processor for executing said instructions; a recipe creator wallet in communication with said recipe creator computational device; a server, comprising a memory for storing a plurality of instructions and a processor for executing said instructions, and a blockchain interface for interacting with the blockchain; and a computer network for communicating between said recipe creator computational device and said server; wherein said recipe creator computational device is configured to perform the following instructions: receive said recipe, send said recipe to said server and receive an NFT corresponding to said recipe from said server; and wherein said server is configured to perform the following instructions: receive said recipe from said recipe creator computational device; cause said NFT corresponding to said recipe to be created through execution of a smart contract on the blockchain, through said blockchain interface; and cause a private key corresponding to said NFT to be stored in said recipe creator wallet.
2. The system of aspect 1, further comprises a marketplace computational device for publishing information about said recipe, wherein said server instructs said marketplace computational device to publish said information.
3. The system of aspect 2, wherein said marketplace computational device publishes said information to a social media channel, a metaverse, a website or a combination thereof.
4. The system of aspect 2 or 3, wherein said marketplace computational device publishes said information to a plurality of food preparation entities.
5. The system of aspect 4, wherein said food preparation entities are selected from the group consisting of online restaurants, offline restaurants, caterers and other food preparers.
6. The system of any of the above aspects, further comprising a purchasing computational device, comprising a memory for storing a plurality of instructions and a processor for executing said instructions; wherein said purchasing computational device is in communication with a purchasing wallet; wherein said purchasing computational device causes a smart contract to be executed to purchase said NFT, such that said private key for said NFT is transferred to said purchasing wallet.
7. The system of aspect 6, wherein a marketplace for each NFT corresponding to a recipe is managed through execution of a plurality of smart contracts.
8. The system of any of the above aspects, wherein said recipe comprises text, video and a secret instruction for using said recipe, all of which are included in said NFT.
9. The system of any of the above aspects, wherein said recipe creator computational device further sends instructions to said server to determine at least one transaction parameter.
10. The system of aspect 9, wherein said transaction parameters are selected from the group consisting of a type of transaction and a price per transaction.
11. The system of aspect 10, wherein said type of transaction is selected from the group consisting of buying, leasing to a single entity and leasing to a plurality of entities.
12. The system of any of the above aspects, wherein said NFT is created according to the ERC721 standard.
13. The system of any of the above aspects, wherein said blockchain interface is selected from the group consisting of an interface to a separate server interacting with the blockchain, a blockchain bridge to the blockchain, and a node of the blockchain.
14. The system of any of the above aspects, further comprising a matching server, wherein said matching server comprises an AI model, wherein said AI model is in communication with said marketplace computational device for managing publication of said information about said recipe.
15. A method to create a private market for cooking recipes as a means to create a new assets class that never existed before comprising of:
   As a non-fungible-token (NFT)
   As a fungible token
   Distributing the contents to token holders
   Distributing the content to meal delivery services comprising restaurants
16. A method to convert contents comprising of:
   Videos
   Blog
   Cookbooks
   Website recipe collections
   Handwritten notes
   Offline restaurants recipes and menus
17. A method to tokenize recipes means a new asset class is created as #RecipesAsNFT that never excited before:
   a. That credits the owner of the creation with the rights to sell and lease the assets
18. A method to tokenize secrets and deep professional know-how mean that the said know-how can be delivered to the person who has appropriate crypto addresses and therefore have access to:
   Secrets and know-hows as #SecrectsAsNFT
   Use the secrets and know-how to use in the operations of distributed digital restaurants
19. A method to tokenize the menu means a new asset class is created that did not exist before where:
   Chefs, Content Creators, Influencers, Consumers, and Restaurants can create a new asset class as #MenuAsNFT
   The said artificial intelligence engine can create a new asset class as #MenuAsNFT
   The said co-pilot discovery services can create a new asset class as #MenuAsNFT
20. A method to tokenize the creation of new meal delivery services means
   A method to create a new category of digital restaurants that never existed before
   A method to create a new category of NFT-enabled enabled restaurants that never existed before
   A method to create a new category of AI-enabled restaurants that never existed before
21. A method to tokenize the meal delivery services means:
A method to create meals based on NFT recipes and NFT menus that get executed through the use of smart contracts with human intervention. This capability never existed before with human intervention.
A method to package the contents based on the recommendations of the AI engine to create various meal services.
22. A method to tokenize assets of meal delivery services means:
A method to borrow recipes and ideas from some and use that idea to deliver meal service based on the content available in the private market
A method to request recipes and menus that customers like to be cooked by distributed meal delivery services
23. A method to tokenize consumer access to meal delivery services means:
   a. A new method to create utility tokens that give access to the contents that the artificial engine discovers for the individual customers
24. A method for tokenization of exclusivity means:
   a. A new method to issue utility tokens to gain access to distributed meal services comprising restaurants.
25. A method to tokenize autonomous operations of distributed meal delivery services comprising restaurants means:
A method to create DAO services to run meal services autonomously
A method to create incentive tokens to run meal services autonomously
26. A method to create an online Marketplace means:
   A method to create a new service to buy the new asset class created in the private market that never existed before
   A method to create a new service to sell the new assets class created that creates a new revenue stream for creators
   A method to create a new service to lease the new asset class created in the private market and collect a royalty
27. A method to create a discovery engine to match contents with the audience means:
   a. A method to create a new artificial intelligence engine to discover content for the audience related to recipes, menus, locations, collections
28. A method to create a discovery engine to match the audience with content means:
   a. A method to create a new artificial intelligence engine to discover the audience for content and content creators
29. A method to buy discovered assets means:
   a. A new method to buy the said discovered assets
30. A method to sell assets means:
   a. A new method to sell their own content and know-how to the marketplace
31. A method to lease means:
   a. A new method to lease the contents and collect a royalty
32. A method to create an operational artificial intelligence engine means:
   A method to discover the in-demand content comprising recipes, menus
   A method to personalize the content for customers
   A method to personalize the content to distributed delivery locations
   A method to discover the contents that are personalized to customers and send it to distributed delivery locations
33. The creation of a co-pilot means for meal delivery services is:
   A new category of distributed meal delivery services comprising restaurants is created
   A new service that works to bring the right set of audience to the meal delivery services
34. A method to create a co-pilot means for customers is:
   A method to create recommendations of recipes and menus based on the co-pilot engine for the customer
   A method to create personalization services for the customers
35. A method to create a co-pilot means for recipes and menus is:
   A method to compare recipes and menus based on their personalization
   A method to compare the audience size for each set of recipes and menus by distributed meal delivery services
36. A method to create co-pilot means for the schedule is:
   A method for customers to schedule meals to be experienced in meal delivery locations
   A method for distributed meal delivery services to schedule the recipes and menu
37. A method to create co-pilot means for the confirmation of services is:
   A method for customers to pay for their service in traditional payment channels and new crypto payment channels.
   A method for distributed meal delivery services to confirm the menu and send customer notifications

What is claimed is:

1. A method of personalizing services associated with restaurants for providing a marketplace for facilitating transactions, wherein the method comprises:
receiving, using a communication device, one or more user data associated with one or more users from one or more devices, wherein the one or more users comprises one or more customers of one or more restaurants;
analyzing, using a processing device, the one or more user data using one or more machine learning models, wherein the one or more machine learning models is trained for detecting a degree of affinity of the one or more users towards one or more ingredients based on the one or more user data;
determining, using the processing device, one or more preferences of the one or more customers based on the analyzing, wherein the one or more preferences comprises one or more selection parameters for selecting one or more of the one or more ingredients;
determining, using the processing device, one or more recipes preferred by the one or more customers based on the determining of the one or more preferences, wherein the one or more recipes is created using one or more of the one or more ingredients;
generating, using the processing device, a menu of the one or more restaurants for the one or more customers based on the determining of the one or more recipes, wherein the menu is comprised of one or more foods created using the one or more recipes;
transmitting, using the communication device, the menu to one or more restaurant devices associated with the one or more restaurants; and
storing, using a storage device, the one or more preferences of the one or more users for the one or more recipes in a distributed ledger.

2. The method of claim 1 further comprises:
identifying, using the processing device, one or more characteristics of recipes based on the determining of the one or more preferences;
retrieving, using the storage device, two or more nonfungible tokens (NFTs) of two or more recipes from the distributed ledger;
analyzing, using the processing device, the two or more NFTs based on the one or more preferences; and
identifying, using the processing device, one or more nonfungible tokens (NFTs) of the one or more recipes based on the analyzing of the two or more NFTs, wherein the determining of the one or more recipes is further based on the identifying of the one or more NFTs.

3. The method of claim 1 further comprises:
identifying, using the processing device, one or more nonfungible tokens (NFTs) of the one or more recipes based on the determining of the one or more recipes;
providing, using the processing device, a marketplace to the one or more restaurants for acquiring the one or more NFTs;
receiving, using the communication device, one or more requests associated with the one or more restaurants for the acquiring of the one or more NFTs from the one or more restaurant devices associated with the one or more restaurants; and
processing, using the processing device, a transaction for the acquiring of the one or more NFTs by the one or more restaurants based on the one or more requests, wherein the generating of the menu for the one or more restaurants is further based on the transaction.

4. The method of claim 3 wherein the one or more requests comprises one or more acquiring parameters for the acquiring of the one or more NFTs, wherein the method further comprises:
analyzing, using the processing device, the one or more acquiring parameters; and
determining, using the processing device, a category from a plurality of categories of the transaction, wherein the processing of the transaction is further based on the determining of the category.

5. The method of claim 3 further comprises:
generating, using the processing device, one or more transaction data associated with the transaction of the one or more NFTs; and
storing, using the storage device, the one or more transaction data in the distributed ledger.

6. The method of claim 5 further comprises:
retrieving, using the storage device, two or more previous transaction data associated with a previous transaction of two or more nonfungible tokens (NFTs) of two or more recipes from the distributed ledger;
analyzing, using the processing device, the two or more previous transaction data using one or more first machine learning models, wherein the one or more first machine learning models determines parameters of a demand for recipes;
determining, using the processing device, a level of demand for each of two or more recipes associated with the two or more NFTs based on the analyzing of the two or more previous transaction data;
generating, using the processing device, a suggestion for the menu for the one or more restaurants based on the determining of the level of demand; and
transmitting, using the communication device, the suggestion to the one or more restaurant devices.

7. The method of claim 1 further comprises:
receiving, using the communication device, two or more recipe information associated with two or more recipes from one or more recipe creator devices associated with one or more recipe creators;
creating, using the processing device, two or more nonfungible tokens (NFTs) of two or more recipes based on the two or more recipe information; and
storing, using the storage device, the two or more NFTs in the distributed ledger.

8. The method of claim 7, wherein the creating of the two or more nonfungible tokens (NFTs) of the two or more recipes comprises creating the two or more nonfungible tokens (NFTs) of the two or more recipes according to ERC721 standard.

9. The method of claim 1 further comprises:
receiving, using the communication device, one or more additional information associated with the one or more customers from one or more external devices, wherein the one or more additional information indicates an inclination of the one or more customers towards one or more aspects of the recipes; and
analyzing, using the processing device, one or more additional information using the one or more machine learning models, wherein the determining of the one or more preferences is further based on the analyzing of the one or more additional information.

10. The method of claim 1, wherein the one or more devices further comprises one or more sensors, wherein the one or more sensors is configured for generating one or more sensor data based on detecting one or more customer characteristics associated with the one or more customers, wherein the one or more user data comprises the one or more sensor data.

11. A system for personalizing services associated with restaurants for providing a marketplace for facilitating transactions, the system comprising:
a communication device configured for:
receiving one or more user data associated with one or more users from one or more devices, wherein the one or more users comprises one or more customers of one or more restaurants; and
transmitting a menu to one or more restaurant devices associated with the one or more restaurants;
a processing device communicatively coupled with the communication device, wherein the processing device is configured for:
analyzing the one or more user data using one or more machine learning models, wherein the one or more machine learning models is trained for detecting a degree of affinity of the one or more users towards one or more ingredients based on the one or more user data;
determining one or more preferences of the one or more customers based on the analyzing, wherein the one or more preferences comprises one or more selection parameters for selecting one or more of the one or more ingredients;
determining one or more recipes preferred by the one or more customers based on the determining of the one or more preferences, wherein the one or more recipes is created using one or more of the one or more ingredients; and
generating the menu of the one or more restaurants for the one or more customers based on the determining of the one or more recipes, wherein the menu is comprised of one or more foods created using the one or more recipes; and
a storage device communicatively coupled with the processing device, wherein the storage device is configured for storing the one or more preferences of the one or more users for the one or more recipes in a distributed ledger.

12. The system of claim 11, wherein the processing device is further configured for:
identifying one or more characteristics of recipes based on the determining of the one or more preferences;
analyzing two or more NFTs based on the one or more preferences; and
identifying one or more nonfungible tokens (NFTs) of the one or more recipes based on the analyzing of the two or more NFTs, wherein the determining of the one or more recipes is further based on the identifying of the one or more NFTs, wherein the storage device is further configured for retrieving the two or more nonfungible tokens (NFTs) of two or more recipes from the distributed ledger.

13. The system of claim 11, wherein the processing device is further configured for:
identifying one or more nonfungible tokens (NFTs) of the one or more recipes based on the determining of the one or more recipes;
providing a marketplace to the one or more restaurants for acquiring the one or more NFTs; and
processing, using the processing device, a transaction for the acquiring of the one or more NFTs by the one or more restaurants based on one or more requests, wherein the generating of the menu for the one or more restaurants is further based on the transaction, wherein the communication device is further configured for receiving the one or more requests associated with the one or more restaurants for the acquiring of the one or more NFTs from the one or more restaurant devices associated with the one or more restaurants.

14. The system of claim 13, wherein the one or more requests comprises one or more acquiring parameters for the acquiring of the one or more NFTs, wherein the processing device is further configured for:
analyzing the one or more acquiring parameters; and
determining a category from a plurality of categories of the transaction, wherein the processing of the transaction is further based on the determining of the category.

15. The system of claim 13, wherein the processing device is further configured for generating one or more transaction data associated with the transaction of the one or more NFTs, wherein the storage device is further configured for storing the one or more transaction data in the distributed ledger.

16. The system of claim 15, wherein the storage device is further configured for retrieving two or more previous transaction data associated with a previous transaction of two or more nonfungible tokens (NFTs) of two or more recipes from the distributed ledger, wherein the processing device is further configured for:
analyzing the two or more previous transaction data using one or more first machine learning models, wherein the one or more first machine learning models determines parameters of a demand for recipes;
determining a level of demand for each of two or more recipes associated with the two or more NFTs based on the analyzing of the two or more previous transaction data; and
generating a suggestion for the menu for the one or more restaurants based on the determining of the level of demand, wherein the communication device is further configured for transmitting the suggestion to the one or more restaurant devices.

17. The system of claim 11, wherein the communication device is further configured for receiving two or more recipe information associated with two or more recipes from one or more recipe creator devices associated with one or more recipe creators, wherein the processing device is further configured for creating two or more nonfungible tokens (NFTs) of two or more recipes based on the two or more recipe information, wherein the storage device is further configured for storing the two or more NFTs in the distributed ledger.

18. The system of claim 17, wherein the creating of the two or more nonfungible tokens (NFTs) of the two or more recipes comprises creating the two or more nonfungible tokens (NFTs) of the two or more recipes according to ERC721 standard.

19. The system of claim 11, wherein the communication device is further configured for receiving one or more additional information associated with the one or more customers from one or more external devices, wherein the one or more additional information indicates an inclination of the one or more customers towards one or more aspects of the recipes, wherein the processing device is further configured for analyzing one or more additional information using the one or more machine learning models, wherein the determining of the one or more preferences is further based on the analyzing of the one or more additional information.

20. The system of claim 11, wherein the one or more devices further comprises one or more sensors, wherein the one or more sensors is configured for generating one or more sensor data based on detecting one or more customer characteristics associated with the one or more customers, wherein the one or more user data comprises the one or more sensor data.
